(19) United States
(12) Patent Application Publication
(10) Pub. No.: US 2025/0254257 A1
(43) Pub. Date: Aug. 7, 2025

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: NOBUO KAWASAKI, Chiba (JP)

(21) Appl. No.: 19/039,673

(22) Filed: Jan. 28, 2025

(30) Foreign Application Priority Data
Feb. 2, 2024 (JP) 2024-014585

(51) Int. Cl. H04N 1/00; G06F 21/10

(52) U.S. Cl. CPC H04N 1/00962; G06F 21/106; H04N 1/00938; G06F 2221/2111

(57) ABSTRACT

A control method includes, in a case where, although processing for activating a first application program has been performed by the second application program after predetermined processing including processing for the first search processing has been performed by the second application program launched based on the launch processing having been performed, a predetermined setting is not enabled in the information processing apparatus, disabling a specific setting for performing a predetermined function, which is a function of the first application program and is a function including processing for the first search processing.

### BACKGROUND OF THE DISCLOSURE

### Field of the Disclosure

Aspects of the present disclosure generally relate to an information processing apparatus, a control method, and a storage medium.

### Description of the Related Art

Japanese Patent Application Laid-Open No. 2022-30782 discusses a technique concerning permission of the use of a location-based service.

Furthermore, with the popularization of a configuration which performs processing that is based on a setting for using a location-based service, it has been desired to increase the convenience of such a configuration.

### SUMMARY OF THE DISCLOSURE

Aspects of the present disclosure are generally directed to increasing the convenience of a configuration which performs processing that is based on a setting for using a location-based service.

According to an aspect of the present disclosure, a control method for an information processing apparatus including a first application program includes performing launch processing for launching a second application program capable of performing processing for first search processing which is processing to be performed based on a predetermined setting for using a location-based service of the information processing apparatus being enabled in the information processing apparatus and which is processing for searching for one or a plurality of communication apparatuses, in a case where, although processing for activating the first application program has been performed by the second application program after predetermined processing including processing for the first search processing has been performed by the second application program launched based on the launch processing having been performed, the predetermined setting is not enabled in the information processing apparatus, disabling a specific setting for performing a predetermined function, which is a function of the first application program and is a function including processing for the first search processing; and in a case where the specific setting is enabled, performing the predetermined function based on the first application program having launched and, in a case where the specific setting is disabled, not performing the predetermined function even if the first application program has launched.

Further features of the present disclosure will become apparent from the following description of exemplary embodiments with reference to the attached drawings.

### BRIEF DESCRIPTION OF THE DRAWINGS

FIG. 1 is a diagram illustrating an example of an information processing system.

FIGS. 2A and 2B are flowcharts illustrating processing which an information processing apparatus performs via a first application.

FIG. 3 is a diagram illustrating an example of a screen for software license obtainment.

FIG. 4 is a diagram illustrating an example of an inquiry screen.

FIG. 5 is a diagram illustrating an example of a top screen.

FIG. 6 is a diagram illustrating an example of a setting screen for changing settings concerning a location-based service.

FIG. 7 is a flowchart illustrating setup processing which the information processing apparatus performs via a second application.

FIG. 8 is a flowchart illustrating processing concerning the location-based service.

FIG. 9 is a flowchart illustrating connection setting processing.

FIG. 10 is a flowchart illustrating first connection setting processing.

FIG. 11 is a flowchart illustrating second connection setting processing.

FIGS. 12A and 12B are diagrams illustrating examples of a first guidance screen and a second guidance screen, respectively.

FIG. 13 is a flowchart illustrating end processing for the second application.

FIG. 14 is a diagram illustrating an example of a list screen.

FIG. 15 is a diagram illustrating an example of an interface (IF) selection screen.

FIG. 16 is a diagram illustrating an example of a setting screen for changing automatic search setting.

FIGS. 17A and 17B are diagrams illustrating examples of a dialog for enabling a second setting and a dialog for enabling a third setting, respectively.

FIG. 18 is a diagram illustrating an example of a first notification screen.

FIG. 19 is a diagram illustrating an example of a second notification screen.

### DESCRIPTION OF THE EMBODIMENTS

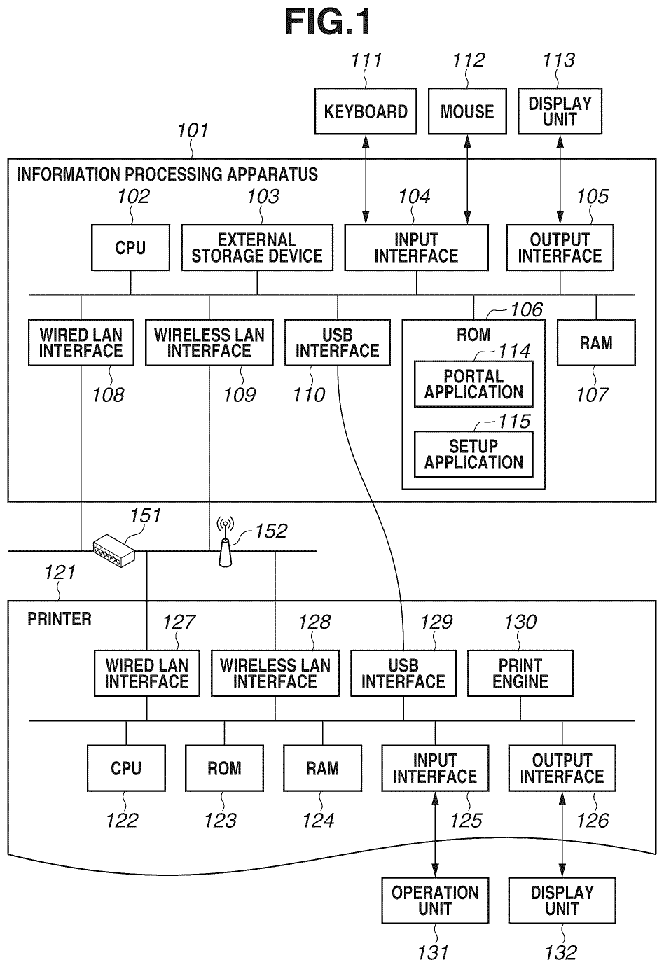

FIG. 1 is a diagram illustrating an example of an information processing system according to an exemplary embodiment of the present disclosure. While, in the present exemplary embodiment, an example in which an information processing apparatus 101 is a personal computer (PC) is described, the present exemplary embodiment is not limited to this example. The information processing apparatus 101 can be, for example, a smartphone or a tablet. The information processing apparatus 101 includes a central processing unit (CPU) 102, an external storage device 103, an input interface 104, an output interface 105, a read-only memory (ROM) 106, a random access memory (RAM) 107, a wired local area network (LAN) interface 108, a wireless LAN interface 109, and a Universal Serial Bus (USB) interface 110.

The CPU 102 is a system control unit, and controls the entire information processing apparatus 101. The CPU 102 performs various processing operations by reading out programs stored in a storage medium, such as the external storage device 103 or the ROM 106, onto the RAM 107 serving as a work area and executing the read-out programs.

The external storage device 103 is a storage device such as a hard disk drive (HDD) or a solid state drive (SSD). The external storage device 103 stores a group of application programs, an operating system (OS), a driver for a printer 121 described below, and various other pieces of data. In the following description, an application program is referred to as an “application”.

To the input interface 104, a keyboard 111 and a mouse 112 are connected. The input interface 104 acquires information about the user received via an input device such as the keyboard 111 or the mouse 112, and then transmits the acquired information to the CPU 102. To the output interface 105, a display unit 113, which is display equipment such as a display, is connected.

The ROM 106 is, for example, a non-volatile storage, and stores fixed data such as programs, data tables, and a built-in operating system (hereinafter referred to as “OS”) program, which the CPU 102 executes. The ROM 106 in the present exemplary embodiment stores, for example, a portal application 114 and a setup application 115. In the following description, the portal application 114 is referred to as a “first application 114”, and the setup application 115 is referred to as a “second application 115”

The first application 114 and the second application 115 are applications related to equipment which is connected to the information processing apparatus 101. In the present exemplary embodiment, the equipment which is connected to the information processing apparatus 101 is a printer 121. The first application 114 is an application capable of issuing an instruction to perform the function of the printer 121, which is connected to the information processing apparatus 101. The second application 115 is an application which performs setup of the printer 121, which is connected to the information processing apparatus 101. In the present exemplary embodiment, the CPU 102 performs various processing operations by reading out the first application 114 and the second application 115 onto the RAM 107 and executing them. Furthermore, in the present exemplary embodiment, the first application 114 is assumed to be a portal application capable of performing not only the function of launching the second application 115 and then causing the second application 115 to perform setup of the printer 121 but also a print job transmission function and a scan job transmission function. The print job transmission function is, specifically, the function of transmitting, to the printer 121, a print job for causing the printer 121 to print image data which the user has selected on the information processing apparatus 101. The scan job transmission function is, specifically, the function of transmitting, to the printer 121, a scan job for causing the printer 121 to perform scanning and causing the printer 121 to transmit image data obtained by scanning to the information processing apparatus 101. Then, the second application 115 is assumed to be an application exclusively for setup, which has the function of performing setup of the printer 121 but has neither the print job transmission function nor the scan job transmission function. However, the present exemplary embodiment is not limited to this configuration, and, for example, the second application 115 can be configured to have the print job transmission function or the scan job transmission function.

Each of the wired LAN interface 108, the wireless LAN interface 109, and the USB interface 110 is a communication interface which performs data communication with external equipment. The wired LAN interface 108 is an interface capable of performing wired communication with external equipment via, for example, a router 151. The wireless LAN interface 109 is an interface capable of performing wireless communication with external equipment via, for example, a wireless LAN access point 152. The USB interface 110 is an interface capable of performing local communication with external equipment.

The configuration of the information processing apparatus 101 is not limited to the above-described configuration, but the information processing apparatus 101 appropriately has a configuration corresponding to functions which a device applied as the information processing apparatus 101 is able to perform.

Next, the hardware configuration of the printer 121 is described. The printer 121 includes a CPU 122, a ROM 123, a RAM 124, an input interface 125, an output interface 126, a wired LAN interface 127, a wireless LAN interface 128, a USB interface 129, and a print engine 130.

Additionally, to the input interface 125, an operation unit 131 is connected, and, to the output interface 126, a display unit 132 is connected. Constituent elements similar to those of the information processing apparatus 101 are omitted from description.

The print engine 130 is, for example, a module which implements print processing by controlling a printing unit (not illustrated) which performs a printing function, based on, for example, print data, print setting, and printing control information received from, for example, the first application 114. The operation unit 131 is, for example, an interface which receives inputting of various settings and instructions for operations from the user.

The information processing apparatus 101 and the printer 121 are made to connect to each other via their interfaces and thus become able to perform communication with each other. For example, the USB interface 110 of the information processing apparatus 101 and the USB interface 129 of the printer 121 can be connected to each other by a USB cable. For example, they may be directly interconnected by one USB cable, or they may be interconnected by two USB cables via a USB hub (not illustrated). In a case where a wired communication is performed between the wired LAN interface 108 of the information processing apparatus 101 and the wired LAN interface 127 of the printer 121, the information processing apparatus 101 and the printer 121 are interconnected via the router 151. In a case where a wireless communication is performed between the wireless LAN interface 109 of the information processing apparatus 101 and the wireless LAN interface 128 of the printer 121, the information processing apparatus 101 and the printer 121 are interconnected via the wireless LAN access point 152. In a case where the router 151 and the wireless LAN access point 152 are present on the same network, both a wired LAN and a wireless LAN are usable for communication. Therefore, the wired LAN interface 108 of the information processing apparatus 101 and the wireless LAN interface 128 of the printer 121 can also be interconnected. Moreover, the wireless LAN interface 109 of the information processing apparatus 101 and the wired LAN interface 127 of the printer 121 can also be interconnected. Furthermore, the router 151 and the wireless LAN access point 152 are connected to the Internet, so that the information processing apparatus 101 and the printer 121 are able to access the Internet via their respective wired LAN interfaces and wireless LAN interfaces. Up to here, as methods for mutual communication between the information processing apparatus 101 and the printer 121, three types of interfaces, i.e., a wired LAN, a wireless LAN, and USB, have been described. For example, not all of the three types of interfaces do not need to be included, and at least one of the three types of interfaces only needs to be included.

### Direct Connection Method

Direct connection refers to a configuration in which apparatuses directly (i.e., peer to peer) perform wireless connection with each other without via an external device such as the wireless LAN access point 152. The direct connection can also be called “peer to peer connection (P2P connection)”. The printer 121 is able to operate with a mode for performing communication by direct connection (direct connection mode) as one of connection modes. With regard to Wi-Fi communication, the mode for performing communication by direct connection includes a plurality of modes such as a software access point (AP) mode and a Wi-Fi Direct (WFD) mode.

The mode for performing direct connection by WFD is referred to as a “WFD mode”. WFD is a standard formulated by the Wi-Fi Alliance, and is a standard included in the communication standards of the IEEE 802.11 series. In the WFD mode, after equipment serving as a communication partner has been searched for by an equipment search command, the roles of a group owner (GO) in peer-to-peer (P2P) communication and a client in P2P communication are determined, and then, the remaining processing operations for wireless connection are performed. The group owner is equivalent to a master station (master device) in Wi-Fi and the client is equivalent to a slave station (slave device) in Wi-Fi. This role determination corresponds to, for example, GO Negotiation in the case of P2P communication. Furthermore, in the WFD mode in a state before the role determination is performed, the printer 121 is in the state of serving as neither a master station nor a slave station. Specifically, first, between pieces of equipment which perform communication, equipment on one side issues an equipment search command to equipment which performs communication and thus searches for equipment to which the equipment on one side connects with the WFD mode. When equipment on the other side serving as a communication partner has been found, the equipment on one side and the equipment on the other side confirm pieces of information about services and functions which they are able to supply between each other. Furthermore, this equipment supply information confirmation is optional and is not essential. This equipment supply information confirmation phase corresponds to, for example, Provision Discovery in P2P communication. Next, they confirm this equipment supply information with respect to one another, and thus determine, as their roles, which serves as a client in P2P communication and which serves as a group owner in P2P communication. Next, after the client and the group owner are determined, they exchange parameters used for performing communication by WFD between them. Based on the exchanged parameters, the client and the group owner in P2P communication perform the remaining processing operations for wireless connection and for Internet Protocol (IP) connection between them. Furthermore, in the case of the WFD mode, the printer 121 can, without performing the above-mentioned GO Negotiation, necessarily operate as the GO (group owner). Thus, the printer 121 can operate with a WFD mode which is an Autonomous GO mode. Moreover, the state in which the printer 121 is operating with the WFD mode is, specifically, for example, a state in which, while the connection using WFD is not yet established, the printer 121 is operating as a GO or a state in which the connection using WFD is currently established and the printer 121 is operating as a GO.

In the case of the software AP mode, between pieces of equipment which perform communication (for example, the information processing apparatus 101 and the printer 121), equipment on one side (for example, the information processing apparatus 101) serves as a client which plays the role of requesting various services. Then, equipment on the other side implements the function of an access point (AP) in Wi-Fi by setting of software. The software AP is equivalent to a master station in Wi-Fi, and the client is equivalent to a slave station in Wi-Fi. In the software AP mode, the client searches for equipment serving as a software AP with use of the equipment search command. When the software AP has been found, the client and the software AP perform the remaining processing operations for wireless connection (such as establishment of wireless connection) between them and, after that, perform processing operations for IP connection (such as allocation of IP addresses). Furthermore, with regard to commands and parameters which are transmitted and received in a case where wireless connection is implemented between the client and the software AP, the ones defined by the Wi-Fi standard can be used therefor, and the description thereof is omitted here.

In the present exemplary embodiment, in a case where the printer 121 is establishing and maintaining direct correction, the printer 121 operates as a master station within a network to which the printer 121 belongs. Furthermore, the master station is a device which builds a wireless network, and is a device which provides parameters used for connection to the wireless network to a slave station. The parameters used for connection to the wireless network are, for example, parameters related to channels which the master station uses. The slave station receives the parameters and thus uses the channels which the master station is using to connect to the wireless network which the master station is building. Since, in the direct connection mode, the printer 121 operates as a master station, the printer 121 is able to determine which frequency band to use for communication in the direct connection mode and which channel to use therefor. In the present exemplary embodiment, the printer 121 is assumed to be able to use, for communication in the direct connection mode, a channel corresponding to a frequency band of 2.4 gigahertz (GHz) and a channel corresponding to a frequency band of 5 GHz.

### Infrastructure Connection Method

The infrastructure connection is a connection form in which pieces of equipment which perform communication (for example, the information processing apparatus 101 and the printer 121) connect to an AP (for example, the wireless LAN access point 152) which comprehensively controls a network for each piece of equipment and pieces of equipment perform communication between them via the AP. The printer 121 is also able to operate with a mode used for performing communication with use of infrastructure connection (infrastructure connection mode) as one of connection modes.

In the infrastructure connection, each piece of equipment searches for an AP with use of the equipment search command. When the AP has been found, the equipment and the AP perform the remaining processing operations for wireless connection (such as establishment of wireless connection) between them and, after that, perform processing operations for IP connection (such as allocation of IP addresses). Furthermore, with regard to commands and parameters which are transmitted and received in a case where wireless connection is implemented between the equipment and the AP, the ones defined by the Wi-Fi standard can be used therefor, and the description thereof is omitted here.

In the present exemplary embodiment, when the printer 121 operates with the infrastructure connection mode, the wireless LAN access point 152 operates as a master device and the printer 121 operates a slave device. Thus, in the present exemplary embodiment, the infrastructure connection refers to a connection between the printer 121 operating as a slave device and a device operating as a master device. In a case where the printer 121 is establishing infrastructure connection and the information processing apparatus 101 is also establishing infrastructure connection with the wireless LAN access point 152, a communication which is performed via the wireless LAN access point 152 is enabled between the printer 121 and the information processing apparatus 101. Since a channel for use in a communication in the infrastructure connection is determined by the wireless LAN access point 152, the printer 121 performs communication in the infrastructure connection with use of the channel determined by the wireless LAN access point 152. In the present exemplary embodiment, the printer 121 is assumed to be able to use a channel corresponding to a frequency band of 2.4 GHz and a channel corresponding to a frequency band of 5 GHz for communication in the infrastructure connection. Furthermore, the printer 121 is also able to use a channel corresponding to a Dynamic Frequency Selection (DFS) band included in a frequency band of 5 GHz for communication in the infrastructure connection. Furthermore, to perform communication with the printer 121 via the wireless LAN access point 152, the information processing apparatus 101 recognizes and identifies that the printer 121 belongs to a network which is formed by the wireless LAN access point 152 and to which the information processing apparatus 101 belongs.

### Direct Connection Setting

In the present exemplary embodiment, the information processing apparatus 101 performs, with use of wireless communication with the printer 121, connection setting (network setting) which is setting for causing the printer 121 to operate with at least one connection method out of infrastructure connection and direct connection. Connection setting processing in the present exemplary embodiment is performed with wireless communication and is, therefore, also called “cableless setup (CLS)”. Furthermore, the connection setting processing can also be performed with wired communication. When the second application 115 stored in, for example, the external storage device 103 is being launched, the information processing apparatus 101 performs connection setting processing on the printer 121. The printer 121 is able to operate with a connection setting mode (connection setting state), which is a mode for performing connection setting processing, and thus performs connection setting processing in the state of being operating with the connection setting mode. The details of the connection setting mode are described below.

When causing the printer 121 to operate with the infrastructure connection mode, the information processing apparatus 101 wirelessly transmits, to the printer 121, infrastructure setting information, which is setting information for causing the printer 121 to operate with the infrastructure connection mode. The infrastructure setting information includes information about the wireless LAN access point 152. The information about the wireless LAN access point 152 is, for example, pieces of information concerning a Service Set Identifier (SSID), a password, and a frequency band thereof.

On the other hand, when causing the printer 121 to operate with the direct connection mode, the information processing apparatus 101 wirelessly transmits, to the printer 121, direct setting information, which is setting information for causing the printer 121 to operate with the direct connection mode. The direct setting information includes instructions for enabling the WFD function to cause the printer 121 to operate as a group owner and for enabling access point setting of the printer 121. Moreover, the information processing apparatus 101 acquires, from the printer 121, connection information required to directly connect to the printer 121. The connection information required to directly connect to the printer 121 includes, for example, pieces of information about, for example, an SSID and a password of the printer 121.

In the present exemplary embodiment, direct connection for connection setting between the information processing apparatus 101 and the printer 121 is used for the transmission of the infrastructure setting information or the direct setting information and the acquisition of the connection information required to directly connect to the printer 121 in the connection setting processing. Then, while, in the present exemplary embodiment, connection setting processing using Wi-Fi is performed as the direct connection for connection setting, for example, a wireless communication standard other than Wi-Fi, such as Bluetooth®, can also be used as the direct connection for connection setting. Moreover, a wired communication standard, such as a wired LAN or Universal Serial Bus (USB), can also be used as the direct connection for connection setting.

After infrastructure connection or direct connection using Wi-Fi has been established by the connection setting processing between the information processing apparatus 101 and the printer 121, communication becomes able to be performed between the information processing apparatus 101 and the printer 121 via the established connection. Specifically, for example, the information processing apparatus 101 is able to transmit, to the printer 121 via the established connection, a print job for causing the printer 121 to perform printing or a scan job for causing the printer 121 to perform scanning. Furthermore, while, in the present exemplary embodiment, the connection setting processing enables both the printer 121 to operate with the infrastructure connection mode and the printer 121 to operate with the direct connection mode, the present exemplary embodiment is not limited to this configuration. For example, a configuration in which the connection setting processing only enables the printer 121 to operate with the infrastructure connection mode (in other words, does not enable the printer 121 to operate with the direct connection mode) can be employed.

### Connection Setting Mode

The printer 121 is able to operate with the connection setting mode. The trigger for the printer 121 to start an operation in the connection setting mode can be, for example, the user pressing a button for connection setting mode or can be the printer 121 being first started up (powered on) after shipment arrival. The button for connection setting mode can be a hardware button included in the printer 121 or can be a software button which the printer 121 displays on the display unit 132.

When starting an operation in the connection setting mode, the printer 121 enables both Wi-Fi communication and Bluetooth® Low Energy (BLE) communication. Specifically, as enabling processing for Wi-Fi communication, the printer 121 enables an access point (AP) arranged inside the printer 121 exclusively used for the connection setting mode (AP for connection setting). This brings the printer 121 into a state of being able to establish direct connection using Wi-Fi with the information processing apparatus 101. Connection information (SSID or password) for connecting to the AP for connection setting is preliminarily stored in the first application 114 or the second application 115 installed on the information processing apparatus 101. Thus, the information processing apparatus 101 is assumed to preliminarily recognize connection information for connecting to the AP for connection setting. Furthermore, a configuration in which no encryption method is set in the AP for connection setting and a password is not required for connection to the AP for connection setting can be employed. Therefore, unlike connection information about an AP which is enabled in the direct connection mode, the connection information for connecting to the AP for connection setting is assumed to be unable to be optionally changed by the user. Furthermore, in the connection setting mode, the printer 121 can connect to the information processing apparatus 101 not by ordinary Wi-Fi but by Wi-Fi Direct (WFD). Thus, the printer 121 can operate as a group owner and receive a setting command from the information processing apparatus 101 by communication using WFD.

The configuration of the printer 121 is not limited to the configuration illustrated in FIG. 1, and appropriately includes constituent elements corresponding to functions which a device applied as the printer 121 is able to perform. Moreover, the printer 121 can be, for example, a printer using an inkjet recording method or a printer using a different recording method, such as an electrophotographic method, a thermal transfer method, or a dot impact method. Moreover, the printer 121 can be a multifunction peripheral (MFP) in which functions of scanner and facsimile are integrally configured.

### Automatic Search Function

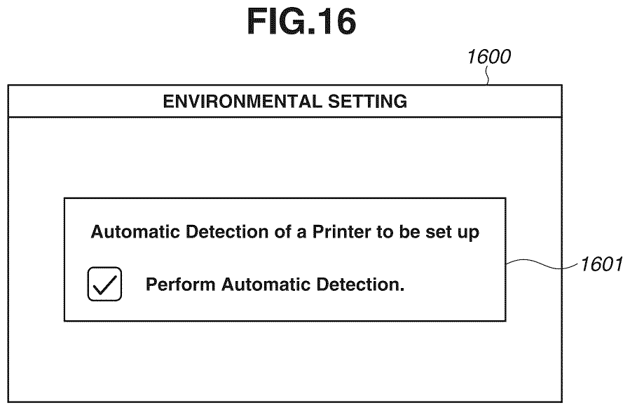

To perform connection setting processing, the information processing apparatus 101 needs to search for a printer 121 which operates with the connection setting mode and then find (detect) the printer 121. Therefore, in the present exemplary embodiment, the first application 114 is assumed to have the function of performing processing (search processing) for searching for a printer 121 which operates with the connection setting mode, based on the first application 114 having been launched. This function is hereinafter referred to as an “automatic search function”. Since the search processing is, in other words, processing for detecting a printer 121 which operates with the connection setting mode, the above-mentioned function is also referred to as “automatic detection processing”. Moreover, the search for a printer 121 which operates with the connection setting mode is, specifically, conducted by processing for searching for an access point present near the information processing apparatus 101 by a communication method that is based on the IEEE 802.11 standard. Such search processing is hereinafter referred to as “first search processing”. Furthermore, there may be a user which does not want processing for searching for a printer 121 which operates with the connection setting mode to be performed based on the first application 114 having been launched. Therefore, in the present exemplary embodiment, in the first application 114, it is possible to enable or disable setting for performing the automatic search function (hereinafter referred to as “automatic search setting”). FIG. 16 illustrates an example of a setting screen 1600 for changing the automatic search setting. The setting screen 1600 is displayed in response to a predetermined user operation being performed on a screen which the first application 114 displays. A checkbox 1601 included in the setting screen 1600 is a checkbox for switching the content of the automatic search setting. In a state in which the automatic search setting is currently set enabled, the first search processing is performed based on the first application 114 having been launched. On the other hand, in a state in which the automatic search setting is currently set disabled, the first search processing is not performed based on the first application 114 having been launched. A configuration in which, even in a state in which the automatic search setting is currently set disabled, in a case where, after the first application 114 has been launched, a predetermined operation for the first search processing has been performed on a screen which the first application 114 displays, the first search processing is performed can be employed.

### Issues to be Solved by Present Exemplary Embodiment

As mentioned above, in the present exemplary embodiment, to perform connection setting processing on the printer 121, the information processing apparatus 101 needs to search for a printer 121 which operates with the connection setting mode and then connect to the printer 121 found by such a search. Then, the search for a printer 121 which operates with the connection setting mode is performed by the first search processing. The first search processing is performed with an OS by an application of the information processing apparatus 101 executing an OS standard application programming interface (API) for instructing the OS to perform the first search processing. The OS standard API for instructing the OS to perform the first search processing is hereinafter referred to as an “API for first search”. In the first search processing, the OS tries to receive a beacon signal which an access point present near the information processing apparatus 101 is issuing. Receiving any beacon signal issued in this manner causes an access point which is issuing the received beacon signal to be found. The application having executed the API for first search acquires, from the OS, information about the access point found by the first search processing, as information indicating a result of the first search processing. This enables the application to recognize an access point which is present near the information processing apparatus 101 and which has been found by the search conducted by the information processing apparatus 101. Furthermore, in the present exemplary embodiment, both the first application 114 and the second application 115 are assumed to be able to execute the API for first search. Moreover, in a case where a communication apparatus is enabling an access point, the communication apparatus which is enabling an access point may be found by the first search processing. Therefore, each application is able to find a printer 121 which is enabling an access point by operating with the connection setting mode.

However, there is a case where, even if the application executes the API for first search, the first search processing is not performed by the OS. The present case is, specifically, for example, a case where the OS of the information processing apparatus 101 is an OS with a version higher than or equal to a predetermined version and a setting item concerning a location-based service which the OS of the information processing apparatus 101 is managing is not set to a predetermined content. Furthermore, the location-based service is a service for the application to use information indicating the location of the information processing apparatus 101, which is information provided by the OS. In the location-based service, the location of the information processing apparatus 101 is identified based on, for example, information acquired from, for example, the Global Positioning System (GPS), an access point, or a base telephone station. Moreover, the OS with a version higher than or equal to a predetermined version is, specifically, macOS Sonoma (version 14). Moreover, the OS with a version lower than the predetermined version is, in other words, an OS with a version lower than the predetermined version, and is, for example, macOS Ventura (version 13). Then, in the present exemplary embodiment, there is assumed to be a first setting which is setting for permitting an application included in the information processing apparatus 101 to use a location-based service. Moreover, there is assumed to be a second setting which is setting for selecting the first application 114 as an application which is permitted by the first setting to use a location-based service. Moreover, there is assumed to be a third setting which is setting for selecting the second application 115 as an application which is permitted by the first setting to use a location-based service. Then, the predetermined content for the first search processing to be performed with the OS by the API for first search which the first application 114 has executed is, specifically, a content in which the first setting is enabled and the second setting is set enabled. The predetermined content for the first search processing to be performed with the OS by the API for first search which the second application 115 has executed is, specifically, a content in which the first setting is enabled and the third setting is set enabled. If the first search processing is not performed by the OS, the information processing apparatus 101 is not able to find a printer 121 which is operating with the connection setting mode, and, as a result, is not able to perform connection setting processing on the printer 121.

Therefore, in the present exemplary embodiment, in a case where, even if the application executes the API for first search, the first search processing is not performed by the OS, processing for performing control in such a manner that, in response to the application having executed the API for first search, the first search processing enters into a state of being performed by the OS is performed. Specifically, in a case where the first setting is disabled, the first application 114 or the second application 115 displays a dialog for prompting the user to enable the first setting.

On the other hand, there is a user who wants to use the first application 114 or the second application 115 while remaining the first setting disabled. Such a user continues using the first application 114 or the second application 115 without enabling the first setting, even if the dialog is displayed in the second application 115. At this time, there is an issue in which, regardless of the fact that the dialog has been displayed in the second application 115, if the dialog is displayed even in the first application 114, the user may feel cumbersome.

Therefore, in the present exemplary embodiment, control is performed in such a manner that, in a case where, even if the first setting is disabled, the dialog has been displayed in the second application 115, the dialog is not additionally displayed in the first application 114. This enables preventing or reducing the cumbersomeness which the user may feel in using the first application 114, and thus enables increasing the convenience of the first application 114.

### Screen for Setting Concerning Location-Based Service

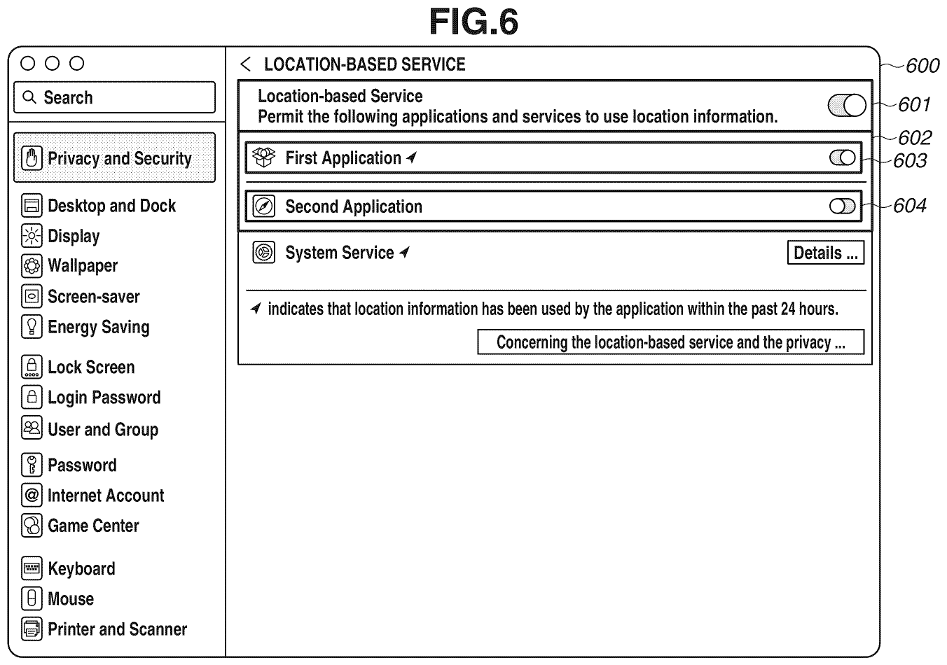

An OS standard setting application included in the information processing apparatus 101 is able to display a setting screen 600 for changing setting concerning a location-based service, such as that illustrated in FIG. 6. The setting screen 600 is displayed within a window which the OS standard setting application displays. In the setting screen 600, a region 601 is a region for enabling or disabling the first setting. In the region 601, a first toggle button is included, and, in response to the first toggle button being operated, the first setting is enabled or disabled. Furthermore, in a case where the first setting is currently enabled, an application which is currently selected as an application which is permitted by the first setting to use a location-based service becomes able to use the location-based service. Even if the first setting is currently enabled, an application which is not currently selected as an application which is permitted by the first setting to use a location-based service is unable to use the location-based service. On the other hand, in a case where the first setting is currently disabled, all of the applications included in the information processing apparatus 101 become unable to use the location-based service. In a case where the first setting is currently disabled, a region 602 described below can be grayed out to disable an operation performed on the region 602. Moreover, in a case where the first setting is currently disabled, all of the settings which are settable in the region 602 can be disabled.

The region 602 is a region for selecting another application other than the OS standard setting application, as an application which is permitted by the first setting to use a location-based service. In the present exemplary embodiment, the region 602 includes a region 603 for enabling or disabling the second setting and a region 604 for enabling or disabling the third setting. The region 603 includes a second toggle button, and, in response to the second toggle button being operated, the second setting is enabled or disabled. Furthermore, in a case where the second setting is currently enabled, the first application 114 is selected as an application which is permitted by the first setting to use a location-based service, so that the first application 114 becomes able to use the location-based service. On the other hand, in a case where the second setting is currently disabled, the first application 114 is not selected as an application which is permitted by the first setting to use the location-based service, so that the first application 114 becomes unable to use the location-based service. Similarly, the region 604 includes a third toggle button, and, in response to the third toggle button being operated, the third setting is enabled or disabled. Furthermore, in a case where the third setting is currently enabled, the second application 115 is selected as an application which is permitted by the first setting to use a location-based service, so that the second application 115 becomes able to use the location-based service. On the other hand, in a case where the third setting is currently disabled, the second application 115 is not selected as an application which is permitted by the first setting to use a location-based service, so that the second application 115 becomes unable to use the location-based service. Moreover, the region 602 can include a region which relates to an application other than the first application 114 or the second application 115 and is similar the region 603 or the region 604.

Furthermore, in the present exemplary embodiment, the state concerning the second setting is assumed to include a state in which the second setting is currently set enabled, a state in which the second setting is currently set disabled, and a state in which the second setting is currently set neither enabled nor disabled. The state in which the second setting is currently set neither enabled nor disabled is equivalent to a state in which the second setting is in an initial state. Then, the state in which the second setting is in an initial state is equivalent to a state in which neither an operation for setting the second setting enabled nor an operation for setting the second setting disabled is previously performed. Similarly, the state concerning the third setting is assumed to include a state in which the third setting is currently set enabled, a state in which the third setting is currently set disabled, and a state in which the third setting is currently set neither enabled nor disabled. The state in which the third setting is currently set neither enabled nor disabled is equivalent to a state in which the third setting is in an initial state. Then, the state in which the third setting is in an initial state is equivalent to a state in which neither an operation for setting the third setting enabled nor an operation for setting the third setting disabled is previously performed. While, if the state concerning the second setting is the state in which the second setting is currently set enabled or the state in which the second setting is currently set disabled, the region 603 is displayed within the region 602, if the second setting is in an initial state, the region 603 may be not displayed within the region 602. Similarly, while, if the state concerning the third setting is the state in which the third setting is currently set enabled or the state in which the third setting is currently set disabled, the region 604 is displayed within the region 602, if the third setting is in an initial state, the region 604 may be not displayed within the region 602. Thus, in the region 602, only a region concerning an application in which the setting as an application which is permitted by the first setting to use a location-based service has been set enabled or disabled may be displayed.

### Processing which Information Processing Apparatus 101 Performs in Present Exemplary Embodiment

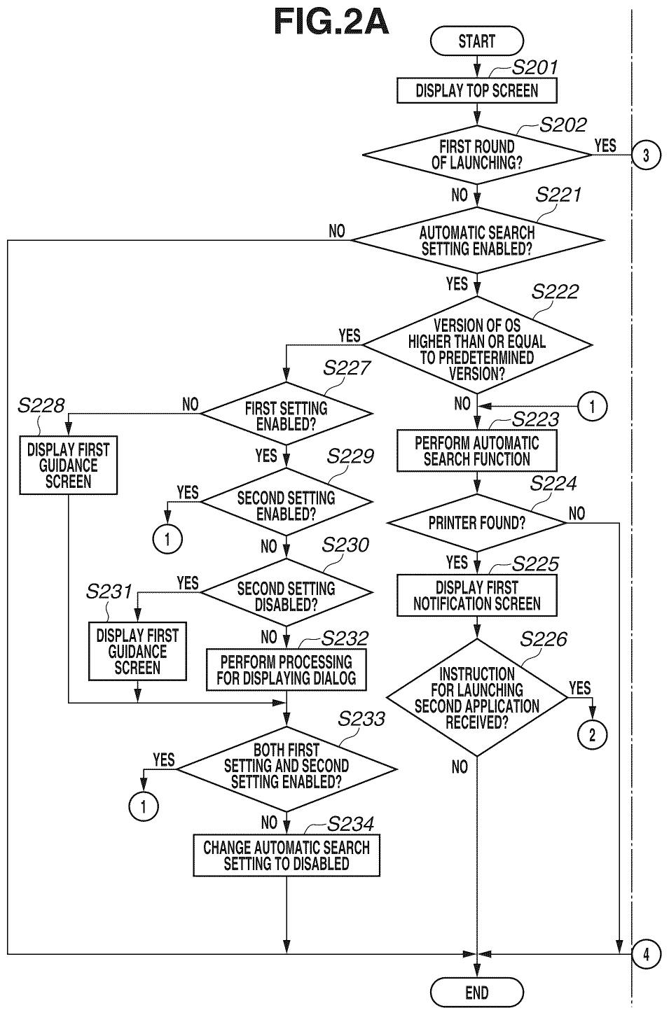

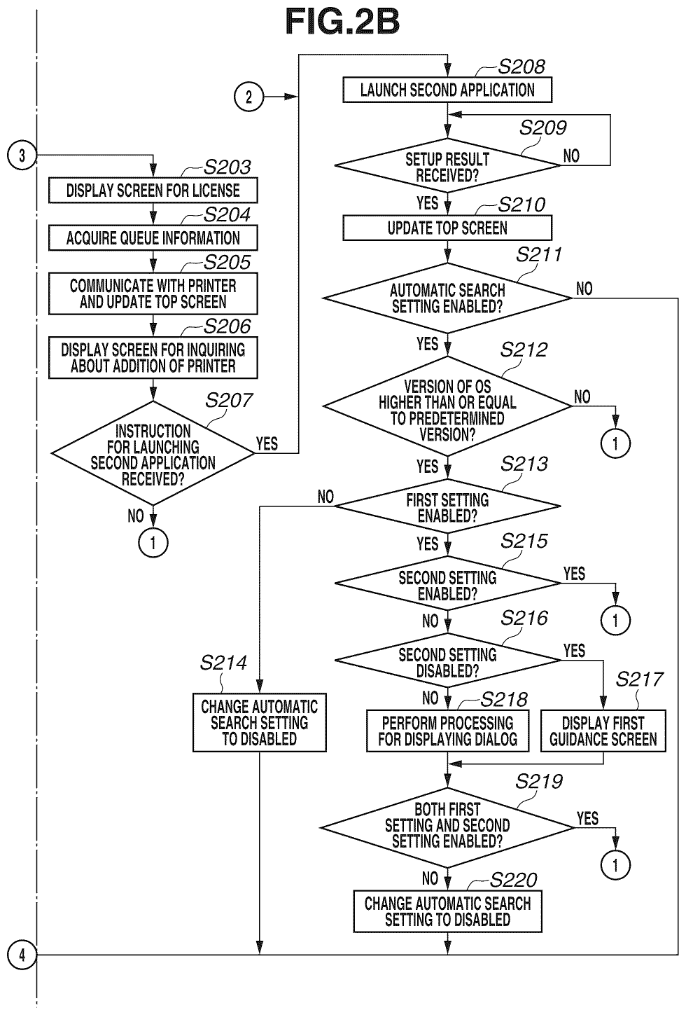

FIGS. 2A and 2B are flowcharts illustrating an example of processing which the information processing apparatus 101 causes the first application 114 to perform in the present exemplary embodiment. The processing which is performed by the first application 114 illustrated in FIGS. 2A and 2B is implemented by, for example, the CPU 102 loading a control program stored in a memory such as the ROM 106 onto the RAM 107 and executing the control program. Moreover, the first application 114 performs the processing illustrated in FIGS. 2A and 2B based on the first application 114 installed on the information processing apparatus 101 having been launched.

In step S201, the first application 114 displays a top screen.

In step S202, the first application 114 determines whether the launching of the first application 114 is the first round of launching. In the present exemplary embodiment, the first round of launching is assumed to include the first launching performed since the first application 114 was installed on the information processing apparatus 101. Moreover, the first round of launching is assumed to include the first launching performed since the first application 114 installed on the information processing apparatus 101 was updated. If the result of the determination is YES (YES in step S202), the first application 114 advances the processing to step S203, and, if the result of the determination is NO (NO in step S202), the first application 114 advances the processing to step S221.

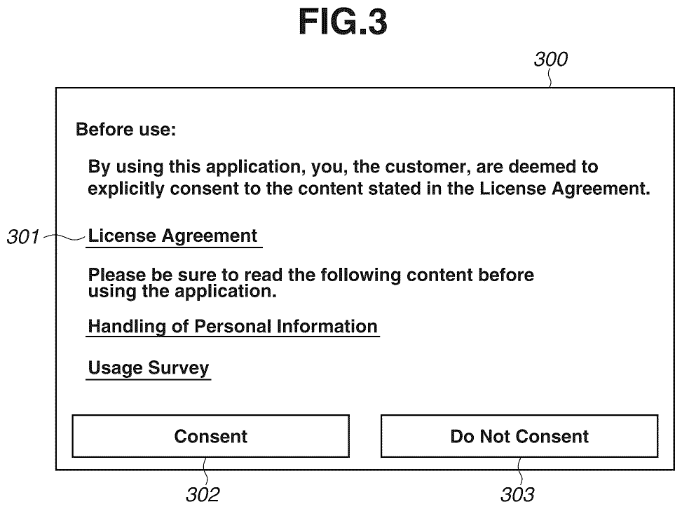

In step S203, the first application 114 performs control for obtaining consent for a software license agreement. The software license agreement is an end-user license agreement (EULA), and, in the following description, the software license agreement may be referred to as a “license agreement”. In the present processing, specifically, the first application 114 displays a screen 300 for a software license agreement illustrated in FIG. 3 on the display unit 113. The screen 300 is, in other words, also a screen which is displayed based on launching of the first application 114. The screen 300 is assumed to be displayed in the foreground of the top screen displayed in step S201, and, in a state in which the screen 300 is being displayed, the top screen is assumed to be grayed out in such a manner that an operation on the top screen is disabled. Moreover, the screen 300 includes, for example, a link 301 to the content of the license agreement, a consent button 302 for the license agreement, and a non-consent button 303 for the license agreement. Thus, the screen 300 is, in other words, also a consent screen for seeking consent from the user. The content of the license agreement also includes, in addition to the content concerning the license agreement of the first application 114, the content concerning the license agreement of the second application 115. Thus, the license agreement serves also as license agreements of a plurality of applications for using the printer 121. In other words, the processing operation in step S203 is control for acquiring both a consent for the software license agreement concerning the first application 114 and a consent for the software license agreement concerning the second application 115. Furthermore, a consent for a software license agreement concerning another application which is provided by a vendor which provides the first application 114 or the second application 115 can be acquired via the screen 300. This results in that, when using a plurality of applications for using the printer 121, the user can no longer be requested for consent for the license agreement. Accordingly, the user becomes able to use each application immediately.

In step S203, in a case where the consent button 302 for the license agreement has been pressed by the user, the first application 114 determines that the user has consented to the content of the license agreement (a consent for the license agreement has been obtained), and then advances the processing to step S204. In step S203, for example, in a case where the non-consent button 303 has been pressed by the user, the first application 114 can end the processing illustrated in FIGS. 2A and 2B.

In step S204, the first application 114 acquires queue information, which is information concerning a print queue, from the OS. The print queue is information which has been created by the OS and is currently managed by the OS, and one or a plurality of print queues is created for every printer. The information processing apparatus 101 performs a communication for the creation of a print queue with a printer to which the information processing apparatus 101 is connecting via various interfaces, so that a print queue corresponding to the printer is created by the OS. In response to a print queue being created by the OS, the information processing apparatus 101 becomes able to transmit various jobs to a printer corresponding to the print queue.

In step S205, the first application 114 communicates with a printer corresponding to the queue information acquired in step S204, and then acquires various pieces of information, such as capability information, from the printer.

Then, the first application 114 updates the top screen based on the information acquired in step S205. In response to the capability information being received from the printer, registration processing for registering the printer with the first application 114 is performed. Then, information about the printer corresponding to the queue information acquired in step S204 is displayed in the updated screen. Furthermore, in a case where, due to there being a plurality of print queues which is being managed by the OS, there is a plurality of printers corresponding to the queue information acquired in step S204, the first application 114 communicates with any one printer out of the plurality of printers. However, the present exemplary embodiment is not limited to this configuration, and the first application 114 can communicate with all of the plurality of printers and acquire pieces of capability information from the respective printers, so that the respective printers can be registered with the first application 114. Moreover, in the present processing operation, the printer serving as a communication partner for the first application 114 is assumed to be a printer which is provided by same vendor as the vendor which provides the first application 114.

In step S206, the first application 114 displays an inquiry screen for inquiring whether to add a new printer as the printer which is to be used by the first application 114.

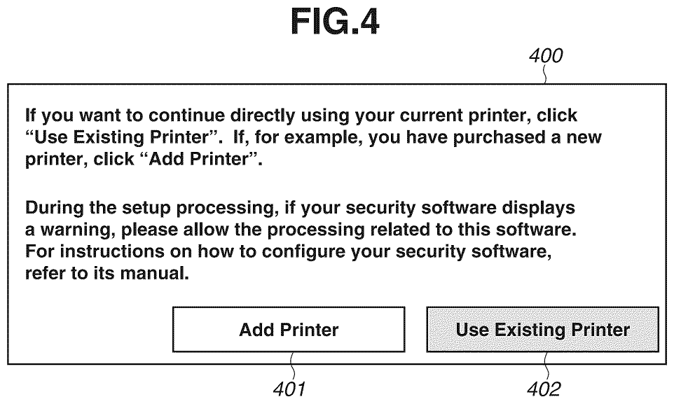

The new printer is, in other words, a printer different from the printer corresponding to the information acquired in step S205. Moreover, in the present exemplary embodiment, the processing operation for adding the new printer is performed by the second application 115. Therefore, the present inquiry screen is equivalent to a screen for inquiring whether to launch the second application 115. In the present processing operation, specifically, the first application 114 displays a screen 400 illustrated in FIG. 4 on the display unit 113. The screen 400 includes a message, a button 401, and a button 402. The message included in the screen 400 is, for example, a message indicating to the user in which use case which button the user should operate. The button 401 is a button for adding a new printer, and is a button for launching the second application 115. The button 402 is a button for, without adding a new printer, using the printer corresponding to the queue information acquired in step S204 via the first application 114. In a case where the button 402 has been pressed, the second application 115 is not launched. The screen 400 is assumed to be displayed in the foreground of the top screen displayed in step S201, and, in a state in which the screen 400 is being displayed, the top screen is assumed to be grayed out in such a manner that an operation on the top screen is disabled.

Furthermore, the communication which is performed in step S205 can include a communication for checking whether the printer is previously subjected to initial setting. Then, in a case where it has been confirmed by that communication that the printer is previously subjected to initial setting, in step S206, the first application 114 can display the screen illustrated in FIG. 4. On the other hand, in a case where it has been confirmed by that communication that the printer is not previously subjected to initial setting, in step S206, the first application 114 can display a second screen different from the screen illustrated in FIG. 4. The second screen is, specifically, a screen which includes the button 401 but does not include the button 402. Moreover, in a case where no queue information has been acquired or in a case where there is no printer which is provided by the same vendor as the vendor which provides the first application 114 as a printer corresponding to the acquired queue information, the first application 114 can display the above-mentioned second screen. In a case where any one button has been pressed in the screen 400, the first application 114 advances the processing to step S207.

In step S207, the first application 114 determines whether the button 401 has been pressed. The button 401 being pressed is, in other words, the reception of an instruction for adding a printer and is the reception of an instruction for launching the second application 115. In a case where the button 402 has been pressed, the result of this determination is NO. If the result of the determination is YES (YES in step S207), the first application 114 advances the processing to step S208, and, if the result of the determination is NO (NO in step S207), the first application 114 advances the processing to step S223.

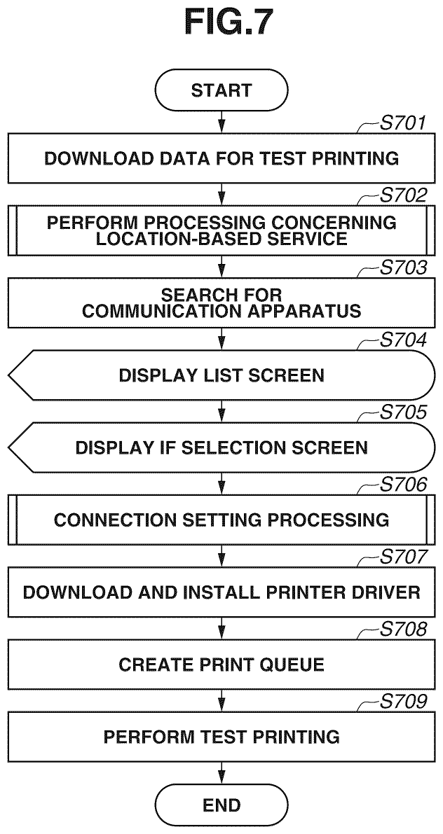

In step S208, the first application 114 performs a processing operation for launching the second application 115 downloaded on the information processing apparatus 101. In the present processing operation, specifically, the first application 114 executes an API for launching the second application 115 and thus performs launch processing which communicates a launch instruction for launching the second application 115 to the OS. The launch instruction for launching the second application 115 includes a launch command for launching the second application 115 and a launch parameter. The launch parameter is information indicating an application serving a launch source for the second application 115, and is appended to the launch command as an option. In the present exemplary embodiment, the launch parameter is appended as a command line argument. Moreover, in the present exemplary embodiment, a command line argument which the first application 114 appends to the launch instruction for the second application 115 as an option is defined as “/BOOT_PORTAL:YES”. Furthermore, the second application 115, which has been launched by the first application 114, performs setup processing for the printer 121. Details of the setup processing for the printer 121 are described below with reference to FIG. 7. Moreover, launching of the second application 115 by a launch instruction which the first application 114 performs is referred to as “cooperative launching of the second application 115”.

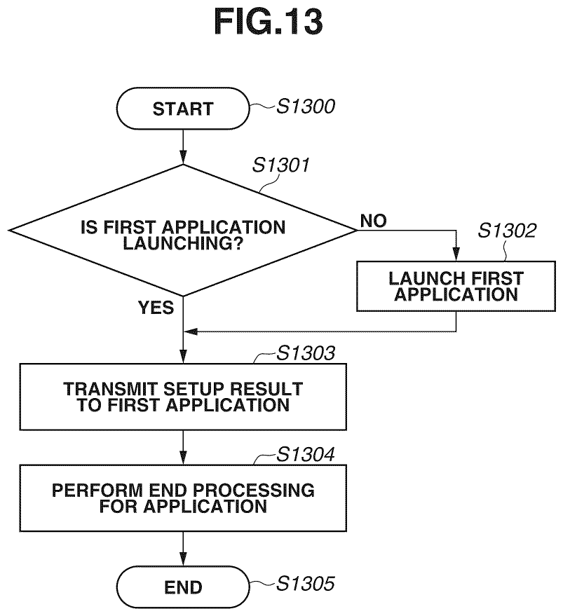

In step S209, the first application 114 determines whether a setup result has been received from the second application 115. If the result of the determination in step S209 is YES (YES in step S209), the first application 114 advances the processing to step S210, and, if the result of the determination in step S209 is NO (NO in step S209), the first application 114 repeats the processing operation in step S209. A specific method in which the first application 114 receives a setup result from the second application 115 is described below with reference to FIG. 13.

First, in step S210, the first application 114 activates the first application 114 itself. In other words, the first application 114 brings the first application 114 itself into an active state. In the present exemplary embodiment, the active state of an application represents a state in which a screen which the application in an active state is displaying is displayed in the foreground of the display unit 113 and a state in which the screen is able to be operated by the user. Moreover, the active state of an application represents a state in which the application is running in the foreground. For example, if, when the second application 115 is performing setup of the printer 121, the user uses another application, a screen for the first application 114 may be displayed behind a screen for such a different application. Even in such a case, in response to the first application 114 bringing the first application 114 itself into an active state, a screen for the first application 114 is displayed in the foreground of the display unit 113 and in the state of being able to be operated by the user. Thus, the first application 114 runs in the foreground. This enables the user to perform an operation on the screen for the first application 114 without hesitation. Moreover, for example, while processing is being performed by the second application 115, the first application 114 may be ended by, for example, an operation performed by the user. Even in such a case, by processing at the end of the second application 115 illustrated in FIG. 13 described below, the first application 114 is launched and the first application 114 is activated. This enables continuing processing subsequent to the processing illustrated in FIGS. 2A and 2B. Furthermore, the activation of the first application 114 is performed, based on the second application 115 having executed an API for activating the first application 114, by an instruction from the OS having received execution of the API. Moreover, the activation of the first application 114 is, in other words, the activation of a window of the first application 114.

Moreover, while a configuration in which, in step S210, the first application 114 enters into an active state irrespective of the state of the screen for the first application 114 itself has been described, the present exemplary embodiment is not limited to this configuration. For example, depending on the state of the screen for the first application 114 or the states of screens for an operating system (OS) of the information processing apparatus 101 and another application, the screen for the first application 114 does not need to be changed into an active state. For example, in a case where the screen for the first application 114 has been minimized by the operation of the user, the first application 114 can be determined to be an application which is intended to give priority to displaying of the window for another application. In this case, in step S210, the first application 114 can, without changing the screen for the first application 114 into an active state, perform, for example, blinking of an application icon of the first application 114 displayed on the display unit 113. For example, blinking of an application icon of the first application 114 enables informing the user that the setup function of the first application 114 has ended.

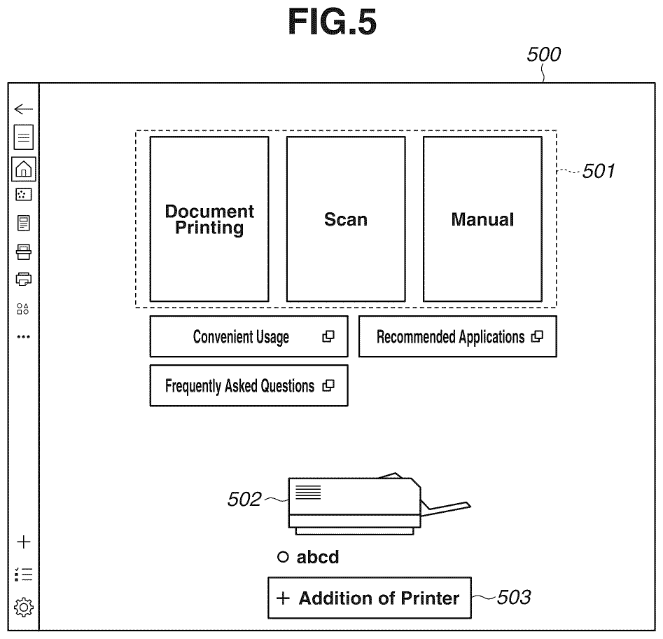

After that, in step S210, the first application 114 updates the top page based on the received setup result. Specifically, the first application 114 registers a printer corresponding to the received setup result with the first application 114. Then, the first application 114 displays, on the display unit 113, a screen for using the function of the printer 121 which has been set up. Thus, the first application 114 is an application which enables the user to issue an instruction to perform the function of the printer 121 which is connected to the information processing apparatus 101. Specifically, the first application 114 displays a top screen 500 illustrated in FIG. 5 on the display unit 113. The top screen 500 includes, for example, printer function buttons 501, a printer icon 502, and a setup start button 503. The setup start button 503 is a button for setting up a new printer 121. The setup start button 503 is, in other words, also a button for adding a new printer 121. Moreover, the printer function buttons 501 are buttons for performing the respective functions of the printer 121, such as printing and scanning. The user is able to perform the functions of the printer 121 by pressing the respective printer function buttons 501. Specifically, for example, the printer function buttons 501 include a button for performing the function of transmitting a print job for causing the printer 121 to perform printing. Moreover, for example, the printer function buttons 501 include a button for performing the function of transmitting a scan job for causing the printer 121 to perform scanning. The printer function buttons 501 can include, for example, a button for displaying a manual of the printer 121. The printer icon 502 is an icon representing a printer which is currently registered with the first application 114, and shows an image corresponding to the model of the printer 121. Furthermore, in step S210, the first application 114 is assumed to use identification information about the printer 121 acquired as a setup result from the second application 115 and thus search for the printer 121 corresponding to the identification information on a network to which the information processing apparatus 101 belongs. Then, the first application 114 acquires various pieces of information, such as capability information, from the printer 121 found by the search. This results in that the printer 121 found by the search is then registered with the first application 114. Then, the printer icon 502 is assumed to be an icon representing the printer 121 found by search. Thus, in step S210, a screen for enabling using the function of the printer 121 is displayed based on the setup of the printer 121 being successful. This enables the user to, after completion of the setup of the printer 121, without launching the first application 114 by the user, use the printer 121, which has been set up, via the top screen 500. Moreover, at this time, the first application 114 can acquire, from the OS, a print queue which is related to the printer 121 corresponding to the above-mentioned identification information and has been registered by the setup processing performed by the second application 115. Then, the printer corresponding to the print queue can be registered with the first application 114 by the print queue.

Furthermore, in a case where the received setup result is a result indicating that the setup of the printer 121 is failed, the first application 114 can display a setup failure notification screen including a message indicating that the setup is failed. Moreover, the first application 114 can display a re-setup guidance screen including a button for starting the setup function again.

Processing operations in step S211 and subsequent steps are performed based on the setup processing performed by the second application 115 being completed. In other words, processing operations in step S211 and subsequent steps are performed based on the first application 114 having been activated based an API executed by the second application 115 or the first application 114 having been launched based an API executed by the second application 115. Additionally, in other words, processing operations in step S211 and subsequent steps are performed based on the first application 114 having received the setup result from the second application 115.

In step S211, the first application 114 determines whether automatic search setting is enabled. If the result of the determination is YES (YES in step S211), the first application 114 advances the processing to step S212, and, if the result of the determination is NO (NO in step S211), the first application 114 ends the processing in the present flowchart without performing the automatic search function or performing processing for enabling the first setting or the second setting. Furthermore, in the present exemplary embodiment, it is assumed that, at the time of the first round of launching of the first application 114, the automatic search setting is currently set enabled. Therefore, at the time of the first round of launching of the first application 114, the result of this determination is necessarily YES. However, at the time of the second and subsequent rounds of launching of the first application 114 and in a case where the present processing operation is performed after step S226, the result of this determination can be YES or can also be NO.

In step S212, the first application 114 determines whether the OS of the information processing apparatus 101 is an OS with a version higher than or equal to a predetermined version. While, in the present exemplary embodiment, the predetermined version is assumed to be macOS Sonoma (version 14), the present exemplary embodiment is not limited to this, and the OS of the information processing apparatus 101 only needs to be a version of the OS in which the setting content of a location-based service is included in an execution condition by the OS of the first search processing.

If the result of the determination is YES (YES in step S212), the first application 114 advances the processing to step S213, and, if the result of the determination is NO (NO in step S212), the first application 114 advances the processing to step S223.

Furthermore, it is assumed to be possible to update the OS included in the information processing apparatus 101 from an OS with a version lower than the predetermined version to an OS with a version higher than or equal to the predetermined version. In that case, on one information processing apparatus 101, the first application 114 can output YES as the result of the determination or can also output NO as the result of the determination. Thus, on one information processing apparatus 101, the first application 114 outputs the result of the determination as NO in the determination performed at timing before updating of the OS, and outputs the result of the determination as YES in the determination performed at timing after updating of the OS. However, with regard to a configuration in which it is impossible to update an OS included in the information processing apparatus 101, on one information processing apparatus 101, the first application 114 outputs the result of the determination as only one of YES and NO. Thus, an information processing apparatus 101 in which the first application 114 is running in a case where the result of the determination becomes YES and an information processing apparatus 101 in which the first application 114 is running in a case where the result of the determination becomes NO are different from each other.

In step S213, the first application 114 determines whether the first setting is currently set enabled. In the present processing operation, specifically, the first application 114 executes an OS standard API for acquiring, from the OS, information indicating whether the first setting is currently set enabled and thus acquires the information. Then, the first application 114 performs the present determination based on the thus acquired information. If the result of the determination is YES (YES in step S213), the first application 114 advances the processing to step S215, and, if the result of the determination is NO (NO in step S213), the first application 114 advances the processing to step S214.

In step S214, the first application 114 changes the automatic search setting to disabled. The present processing operation is assumed to be automatically performed without the setting screen 1600 being displayed and without a user operation performed on the checkbox 1601 being received. After that, the first application 114 ends the processing in the present flowchart.

In step S215, the first application 114 determines whether the second setting is currently set enabled. In the present processing operation, specifically, the first application 114 executes an OS standard API for acquiring, from the OS, information indicating whether the second setting is currently set enabled and thus acquires the information. Then, the first application 114 performs the present determination based on the thus acquired information. If the result of the determination is YES (YES in step S215), the first application 114 advances the processing to step S223, and, if the result of the determination is NO (NO in step S215), the first application 114 advances the processing to step S216.

In step S216, the first application 114 determines whether the second setting is currently set disabled. The first application 114 performs the present determination based on the information acquired from the OS in step S215. Furthermore, the case where the second setting is currently set neither enabled nor disabled is a case where the second setting is in an initial state. If the result of the determination is YES (YES in step S216), the first application 114 advances the processing to step S217, and, if the result of the determination is NO (NO in step S216), the first application 114 advances the processing to step S218.

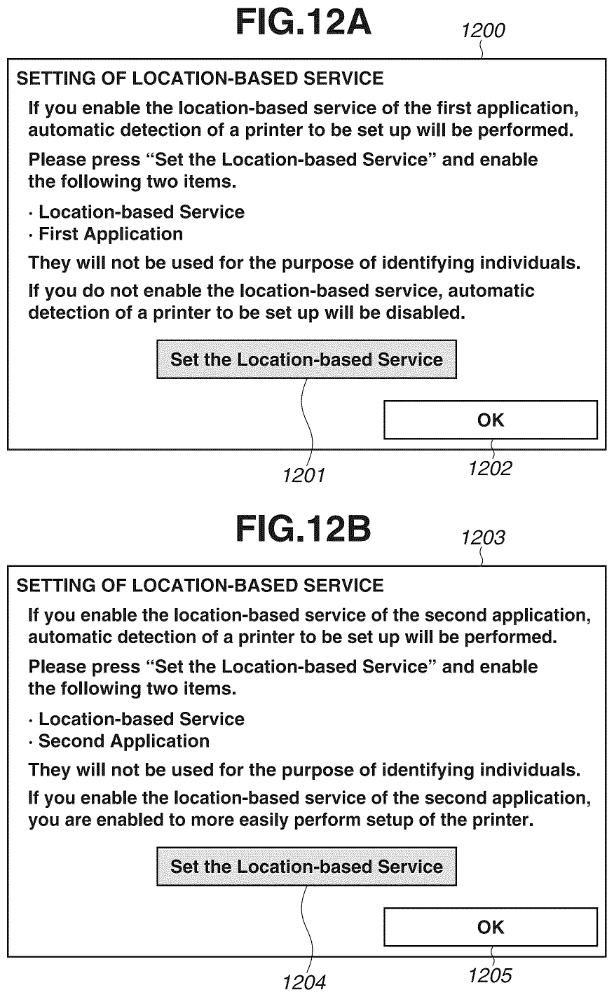

In step S217, the first application 114 performs a processing operation for enabling the second setting. Specifically, the first application 114 displays a first guidance screen for enabling the first setting and the second setting. FIG. 12A illustrates an example of a first guidance screen 1200, which is displayed in the present processing operation. The first guidance screen 1200 is displayed within a window which is displayed by the first application 114. The first guidance screen 1200 includes a message for prompting the user to set the first setting enabled and a message for prompting the user to set the second setting enabled. Furthermore, the message for prompting the user to set the first setting enabled is, in other words, a message for recommending the user to set the first setting enabled. The message for prompting the user to set the second setting enabled is, in other words, a message for recommending the user to set the second setting enabled. Moreover, the first guidance screen 1200 can include a message indicating that, to use the function of the first application 114, it is necessary to set the first setting or the second setting enabled. Furthermore, the first guidance screen 1200 is a screen which is displayed by the first application 114 without an OS standard API being used. Therefore, a message which is displayed in the first guidance screen 1200 is not a message the content of which is controlled by the OS but a message the content of which is controlled by the first application 114. A region 1201 included in the first guidance screen 1200 is a button for displaying the setting screen 600. In response to the region 1201 being pressed, the first application 114 instructs the OS standard setting application to display the setting screen 600. Specifically, the first application 114 executes an OS standard API for displaying the setting screen 600. This causes the setting screen 600 to be displayed, by the OS standard setting application, in a window different from the window at which the first guidance screen 1200 is currently displayed.

The user performs an operation for setting the first setting enabled in the setting screen 600 which is currently displayed. Then, after performing the operation for setting the first setting enabled in the setting screen 600, the user operates a region 1202 included in the first guidance screen 1200. In a case where the region 1202 has been operated, the first application 114 advances the processing to step S219.

Furthermore, at timing when step S217 is performed, the first setting is previously enabled.

Therefore, in the first guidance screen 1200 which is displayed in step S217, a message for prompting the user to set the second setting enabled only needs to be included and a message for prompting the user to set the first setting enabled does not need to be included.

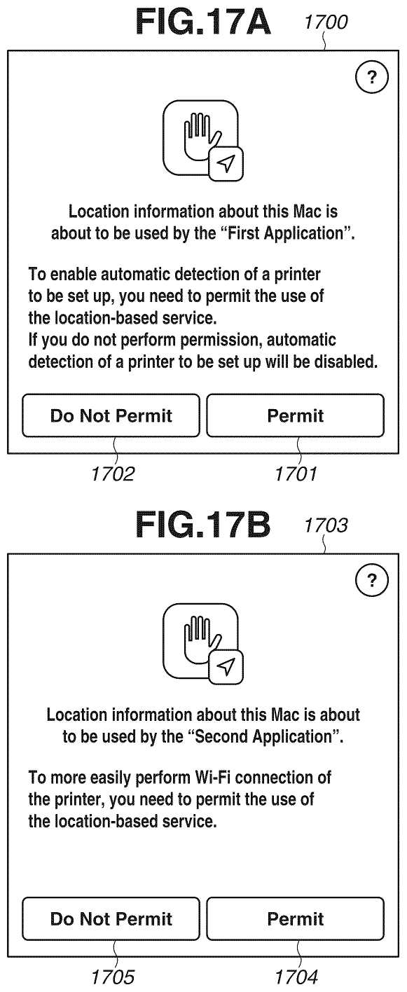

In step S218, the first application 114 performs a processing operation for enabling the second setting. Specifically, the first application 114 performs a processing operation for displaying a dialog for enabling the second setting. In the present processing operation, specifically, the first application 114 executes an OS standard API, which is an API for displaying a dialog for enabling the second setting and is used to request the use of a location-based service from the OS. In response to the API being executed, the dialog is displayed by the OS within a window which the first application 114 is currently displaying. FIG. 17A illustrates an example of a dialog 1700 which is displayed in the present processing operation. The dialog 1700 includes a button 1701 for enabling the second setting and a button 1702 for not enabling the second setting. Moreover, the dialog 1700 includes a message indicating that the first application 114 is trying to use a location-based service. The content of the message is controlled by the OS but is not able to be controlled by the first application 114. However, in the dialog 1700, a message which is able to be controlled by the first application 114 can also be displayed. Specifically, when an OS standard API for displaying the dialog 1700 is executed, the first application 114 communicates an optional message as an argument to the OS, so that the message can be displayed in the dialog 1700. Furthermore, in a case where the first application 114 does not communicate a message as an argument to the OS, a message which the first application 114 controls is not displayed in the dialog 1700. Furthermore, as the message which the first application 114 controls, for example, a message indicting that, to perform the automatic search function, it is necessary to permit the use of a location-based service is displayed. The message is, in other words, a message indicating that, to perform the automatic search function, it is necessary to enable the first setting. Moreover, the message which the first application 114 controls is, for example, a message indicating that, in a case where the use of a location-based service is not permitted, the automatic search function is not performed. The message is, in other words, a message indicating that, in a case where enabling of the first setting is not permitted, the automatic search function is not performed. In a case where the button 1701 has been operated by the user, the OS enables the second setting. Thus, the OS sets a state in which the second setting is currently set enabled. Additionally, the OS notifies the first application 114 that the button 1701 has been operated by the user. On the other hand, in a case where the button 1702 has been operated by the user, the OS disables the second setting. Thus, the OS sets a state in which the second setting is currently set disabled. Additionally, the OS notifies the first application 114 that the button 1702 has been operated by the user. In a case where the button 1701 or the button 1702 has been operated, the dialog becomes hidden. In a case where the button 1701 or the button 1702 has been operated, the first application 114 advances the processing to step S219.

In step S219, the first application 114 determines whether both the first setting and the second setting are currently set enabled. In the present processing operation, specifically, the first application 114 executes an OS standard API for acquiring, from the OS, information indicating whether the first setting is currently set enabled and an OS standard API for acquiring, from the OS, information indicating whether the second setting is currently set enabled. With this execution, the first application 114 acquires such pieces of information from the OS. Then, the first application 114 performs the present determination based on such acquired pieces of information. If the result of the determination is YES (YES in step S219), the first application 114 advances the processing to step S223, and, if the result of the determination is NO (NO in step S219), the first application 114 advances the processing to step S220.

In step S220, the first application 114 changes the automatic search setting to disabled. The present processing operation is similar to that in step S214. After that, the first application 114 ends the processing in the present flowchart.

Furthermore, while, in the above description, in a case where the result of the determination in step S215 is NO, the processing operation for enabling the second setting is performed as a processing operation in step S217 or step S218, the present exemplary embodiment is not limited to this configuration.

In a case where the result of the determination in step S215 is NO, the first application 114 can, while omitting the processing operations in step S216 to step S219, advance the processing directly to step S220.

In step S221, which is performed in a case where the result of the determination in step S202 is NO, the first application 114 determines whether the automatic search setting is enabled. If the result of the determination in step S221 is YES (YES in step S221), the first application 114 advances the processing to step S222, and, if the result of the determination in step S221 is NO (NO in step S221), the first application 114 ends the processing in the present flowchart without performing the automatic search function or performing the processing operation for enabling the first setting or the second setting.

In step S222, the first application 114 determines whether the OS of the information processing apparatus 101 is an OS with a version higher than or equal to the predetermined version. The present processing operation is similar to the processing operation in step S212. If the result of the determination is YES (YES in step S222), the first application 114 advances the processing to step S227, and, if the result of the determination is NO (NO in step S222), the first application 114 advances the processing to step S223.

In step S223, the first application 114 performs the automatic search function. Specifically, first, the first application 114 executes an API for first search and thus acquires a result of first search processing performed by the OS. After that, the first application 114 identifies a printer which is compatible with the first application 114 and is operating with the connection setting mode, from among one or a plurality of devices found by the first search processing. The printer which is compatible with the first application 114 is, for example, a printer which is provided by the same vendor as the vendor which provides the first application 114. Furthermore, the printer which is compatible with the first application 114 does not need to be all of the printers which are provided by the same vendor as the vendor which provides the first application 114, but can be some models of printers of all of the provided printers.

In step S224, the first application 114 determines whether a printer which is compatible with the first application 114 and is operating with the connection setting mode has been found by the first search processing. In a case where, in step S223, a printer which is compatible with the first application 114 and is operating with the connection setting mode has been identified, the result of the determination is YES. On the other hand, in a case where no device has been found by the first search processing, the result of the determination is NO. Moreover, in a case where a printer which is compatible with the first application 114 and is operating with the connection setting mode is not included in one or a plurality of devices found by the first search processing, the result of the determination is NO. If the result of the determination in step S224 is YES, the first application 114 advances the processing to step S225, and, if the result of the determination in step S224 is NO, the first application 114 ends the processing in the present flowchart.

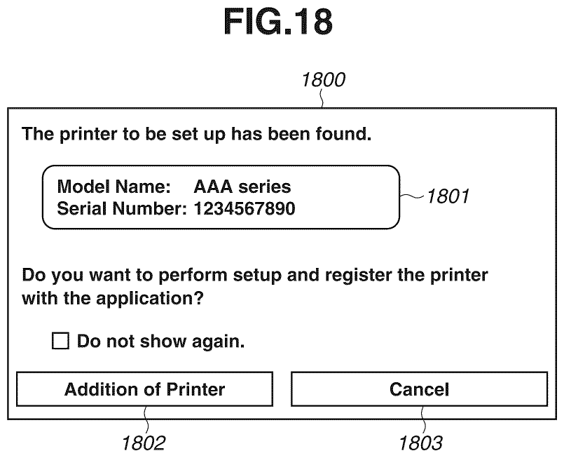

In step S225, the first application 114 displays a first notification screen for notifying the user that a printer which is compatible with the first application 114 and is operating with the connection setting mode has been found. FIG. 18 illustrates an example of a first notification screen 1800 which is displayed in the present processing operation. The first notification screen 1800 includes a region 1801, a button 1802, and a button 1803. The region 1801 is a region for displaying information indicating the found printer. The information indicating the found printer is, for example, a model name (device model name) or serial number of the found printer. These pieces of information are included in a beacon signal which a printer operating with the connection setting mode sends out. The button 1802 is a button for adding a new printer as a printer to be used by the first application 114 and for launching the second application 115. Moreover, in the present exemplary embodiment, the processing operation for adding a new printer is performed by the second application 115. Therefore, the first notification screen 1800 is equivalent to a screen for inquiring whether to launch the second application 115. The button 1803 is a button for selecting not adding a new printer. Therefore, in a case where the button 1803 has been pressed, the second application 115 is not launched. In a case where any button has been pressed in the first notification screen 1800, the first application 114 advances the processing to step S226.

In step S226, the first application 114 determines whether the button 1802 has been pressed. Pressing of the button 1802 is, in other words, reception of an instruction for adding a printer and reception of an instruction for launching the second application 115. In a case where the button 1803 has been pressed, the result of the determination is NO. If the result of the determination is YES (YES in step S226), the first application 114 advances the processing to step S208, and, if the result of the determination is NO (NO in step S226), the first application 114 ends the processing in the present flowchart.

In step S227, which is performed in a case where the result of the determination in step S222 is YES, the first application 114 determines whether the first setting is currently set enabled. The present processing operation is similar to the processing operation in step S213. If the result of the determination is YES (YES in step S227), the first application 114 advances the processing to step S229, and, if the result of the determination is NO (NO in step S227), the first application 114 advances the processing to step S228.

In step S228, the first application 114 displays the first guidance screen 1200. The present processing operation is similar to the processing operation in step S217. Furthermore, in the first guidance screen 1200, which is displayed in step S228, a message for prompting the user to set the first setting enabled only needs to be included and a message for prompting the user to set the second setting enabled does not need to be included.

In a case where the region 1202 has been operated, the first application 114 advances the processing to step S233.

In step S229, the first application 114 determines whether the second setting is currently set enabled. The present processing operation is similar to the processing operation in step S215. If the result of the determination is YES (YES in step S229), the first application 114 advances the processing to step S223, and, if the result of the determination is NO (NO in step S229), the first application 114 advances the processing to step S230.

In step S230, the first application 114 determines whether the second setting is currently set disabled. The present processing operation is similar to the processing operation in step S216. If the result of the determination is YES (YES in step S230), the first application 114 advances the processing to step S231, and, if the result of the determination is NO (NO in step S230), the first application 114 advances the processing to step S232.

In step S231, the first application 114 displays the first guidance screen 1200. The present processing operation is similar to the processing operation in step S217. Furthermore, at timing when step S231 is performed, the first setting is previously enabled. Therefore, in the first guidance screen 1200 which is displayed in step S231, a message for prompting the user to set the second setting enabled only needs to be included and a message for prompting the user to set the first setting enabled does not need to be included. In a case where the region 1202 has been operated, the first application 114 advances the processing to step S233.

In step S232, the first application 114 performs a processing operation for enabling the second setting. The present processing operation is similar to the processing operation in step S218. In a case where the button 1701 or the button 1702 has been operated, the first application 114 advances the processing to step S233.

In step S233, the first application 114 determines whether both the first setting and the second setting are currently set enabled. The present processing operation is similar to the processing operation in step S219. If the result of the determination is YES (YES in step S233), the first application 114 advances the processing to step S223, and, if the result of the determination is NO (NO in step S233), the first application 114 advances the processing to step S234.

In step S234, the first application 114 changes the automatic search setting to disabled. The present processing operation is similar to the processing operation in step S214. After that, the first application 114 ends the processing in the present flowchart.

FIG. 7 is a flowchart illustrating an example of setup processing which the information processing apparatus 101 performs via the second application 115. The processing illustrated in FIG. 7 is implemented, for example, by the CPU 102 loading a control program stored in a memory such as the ROM 106 onto the RAM 107 and executing the control program. The present processing is started by the second application 115 based on the second application 115 having been launched by the processing operation in step S208.

Furthermore, the second application 115, which performs the processing illustrated in FIG. 7, has been launched via the first application 114. Then, in a case where the second application 115 is launched via the first application 114, it is necessary that, in the first application 114, the consent of the user for a software license agreement regarding the second application 115 has previously been acquired in step S203 illustrated in FIG. 2B. Thus, in a case where the second application 115 has been cooperatively launched, it is not necessary that control for acquiring the consent of the user for a software license agreement regarding the second application 115 is performed in the second application 115. Therefore, the second application 115 performs control for not performing the acquisition of a software license agreement, based on the second application 115 having been cooperatively launched. Thus, in the case of cooperative launching, the second application 115 does not display a software license agreement on the display unit 113. This prevents the user from, after launching the first application 114 and consenting to a software license agreement, being requested again to consent to a software license agreement in the second application 115. Furthermore, in the case of having been cooperatively launched, the second application 115 can acquire, from the first application 114, information indicating that the consent of the user for a software license agreement regarding the second application 115 has already been acquired.

Furthermore, while, in the above description, a configuration in which, in a case where the second application 115 has been cooperatively launched, control for acquiring the consent of the user for a software license agreement regarding the second application 115 is not performed in the second application 115 has been described, the present exemplary embodiment is not limited to this configuration. A configuration in which, even in a case where the second application 115 has been cooperatively launched, control for acquiring the consent of the user for a software license agreement regarding the second application 115 is performed in the second application 115 can be employed. In the case of this configuration, the control to be performed in step S203 can be control which acquires the consent for a software license agreement regarding the first application 114 but does not acquire the consent for a software license agreement regarding the second application 115.

In step S701, the second application 115 downloads print data for test printing. The print data is acquired from, for example, a server on the Internet via a connection between the information processing apparatus 101 and the access point.

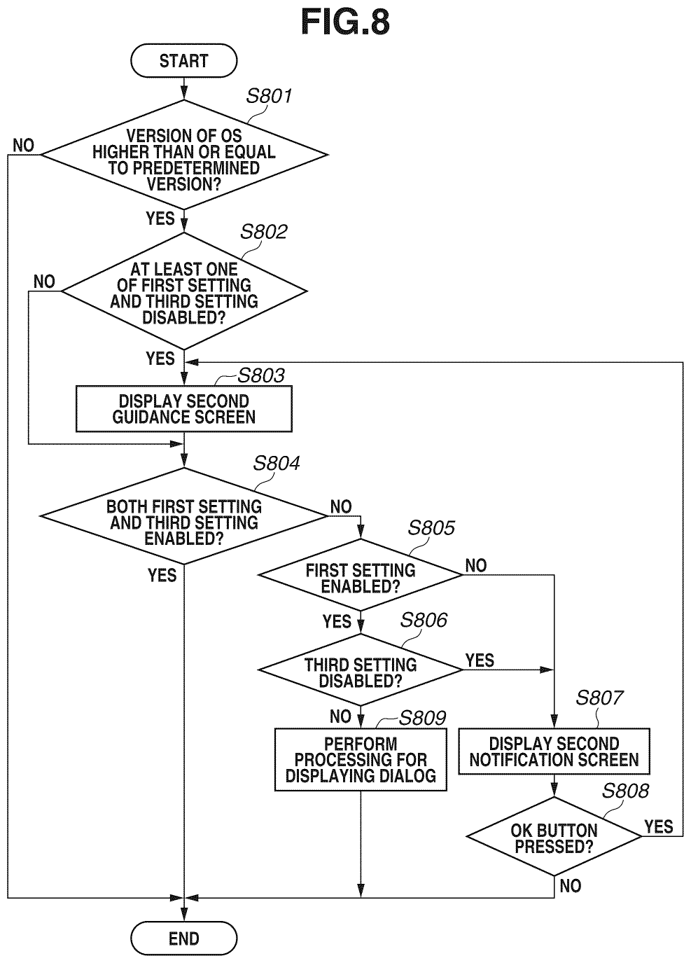

In step S702, the second application 115 performs processing concerning a location-based service. The details of this processing are described below with reference to FIG. 8. Furthermore, while, in the present exemplary embodiment, the processing operation in step S702 is performed after the processing operation in step S701, the present exemplary embodiment is not limited to this. The processing operation in step S702 can be performed in advance of the processing operation in step S701.

In step S703, the second application 115 performs processing for searching for the printer 121. In the present processing operation, specifically, the second application 115 executes an API for first search, thus instructing the OS to perform first search processing. Furthermore, when the API for first search has been executed, in a case where the OS of the information processing apparatus 101 is an OS with a version higher than or equal to a predetermined version and both the first setting and the third setting are currently set enabled, the first search processing is performed by the OS.

Moreover, in a case where the OS of the information processing apparatus 101 is an OS with a version lower than the predetermined version, irrespective of the setting content of the first setting or the third setting, the first search processing is performed by the OS. However, there is a case where the OS of the information processing apparatus 101 is an OS with a version higher than or equal to the predetermined version and at least one of the first setting and the third setting is currently set disabled. Then, in this case, even if the API for first search has been executed by the second application 115, the first search processing is not performed by the OS. In a case where the first search processing has been performed by the OS, the second application 115 acquires information indicating the result of the first search processing from the OS, and, in a case where the first search processing has not been performed by the OS, the second application 115 does not acquire information indicating the result of the first search processing from the OS. Moreover, in the present processing operation, the second application 115 executes an OS standard API (hereinafter referred to as an “API for second search”) for instructing the OS to perform processing (hereinafter referred to as “second search processing”) for searching for a communication apparatus on a network to which the information processing apparatus 101 belongs. With this operation, the second application 115 causes the OS to perform the second search processing. Furthermore, in a case where the API for second search has been executed, irrespective of the version of the OS of the information processing apparatus 101 or the setting content of the first setting or the third setting, the second search processing is performed by the OS. Thus, even in a case where the OS of the information processing apparatus 101 is an OS with a version higher than or equal to the predetermined version and at least one of the first setting and the third setting is currently set disabled, the second search processing is performed by the OS. In a case where the second search processing has been performed by the OS, the second application 115 acquires information indicating the result of the second search processing from the OS. Furthermore, the second search processing is, in other words, processing for searching for a communication apparatus which belongs to a network to which the information processing apparatus 101 belongs. Moreover, the second search processing is performed by broadcasting on the network to which the information processing apparatus 101 belongs. Moreover, the communication apparatus which belongs to a network to which the information processing apparatus 101 belongs is, in other words, a communication apparatus which is connecting to an access point to which the information processing apparatus 101 is connecting. A connection between the information processing apparatus 101 and the access point can be established by a communication method that is based on the IEEE 802.11 standard or a wireless LAN. In a case where there is a plurality of communication apparatuses which belongs to a network to which the information processing apparatus 101 belongs, the plurality of communication apparatuses which belongs to a network to which the information processing apparatus 101 belongs is found by the second search processing.

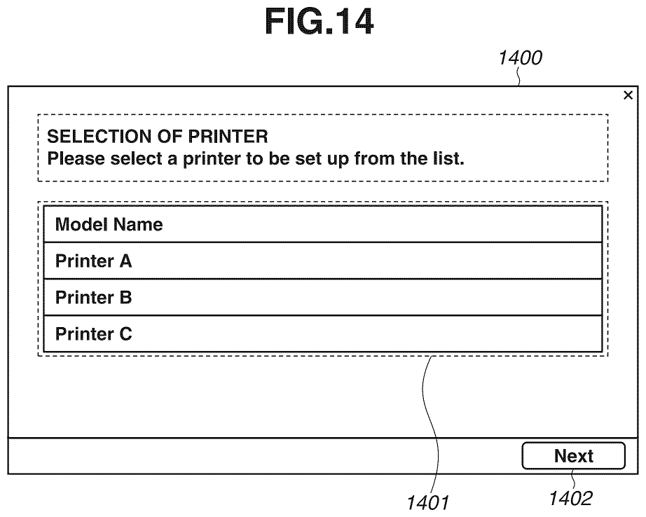

In step S704, the second application 115 displays a list of communication apparatuses found by the search processing performed in step S703. Furthermore, at this time, the second application 115 can identify a communication apparatus with which the second application 115 is compatible out of the communication apparatuses found by the search processing performed in step S703 and display only the identified communication apparatus. In the present exemplary embodiment, the communication apparatus with which the second application 115 is compatible is, specifically, a printer which a vendor which provides the second application 115 provides. Moreover, the communication apparatus with which the second application 115 is compatible is, specifically, a communication apparatus which is operating with the connection setting mode and is enabling an access point having an SSID exclusively for the connection setting mode. FIG. 14 illustrates an example of a list screen 1400, which is a screen to be displayed in the present processing operation. A region 1401 is a region showing a list of communication apparatuses found by the search processing performed in step S703. Since any one communication apparatus is selected by the user from the list displayed in the region 1401, the list screen 1400 can also be said to be a selection screen. In a case where, after any one communication apparatus is selected by the user from the list displayed in the region 1401, a region 1402 has been operated by the user, the second application 115 advances the processing to step S705.

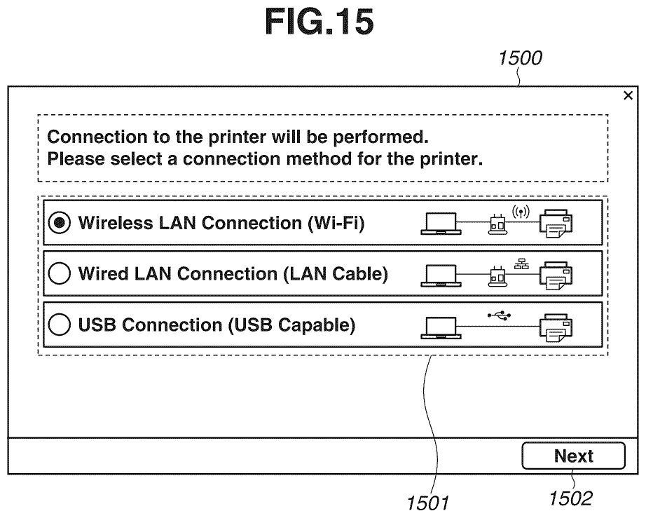

In step S705, the second application 115 displays an IF selection screen for selecting an interface (IF) which is used for the connection setting processing. FIG. 15 illustrates an example of an IF selection screen 1500, which is a screen to be displayed in the present processing operation. A region 1501 is a region for displaying candidates for IFs to be used for the connection setting processing. In the present exemplary embodiment, candidates for IFs to be used for the connection setting processing are assumed to be an IF for wireless LAN communication (Wi-Fi communication), an IF for wired LAN communication, and an IF for USB communication. Furthermore, since the IF to be selected here is an IF which is used for connection between the communication apparatus selected in step S704 and the information processing apparatus 101, the IF selection screen can also be said to be a screen for selecting a method for connection between the communication apparatus selected in step S704 and the information processing apparatus 101. In a case where, after any one is selected by the user from options displayed in the region 1501, a region 1502 has been operated by the user, the second application 115 advances the processing to step S706.

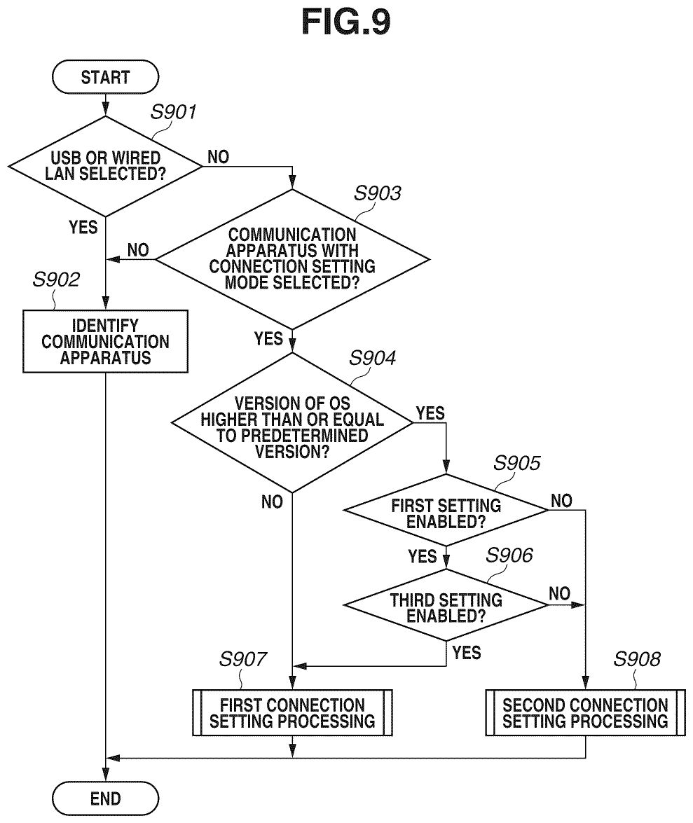

In step S706, the second application 115 performs connection setting processing on the communication apparatus selected in step S704. The details of the present processing are described below with reference to FIG. 9.

In step S707, the second application 115 performs download and install of a printer driver which is compatible with the printer 121 selected in step S704. For example, the second application 115 downloads the printer driver from a server on the Internet via a connection between the information processing apparatus 101 and the access point. Furthermore, the present exemplary embodiment is not limited to the present processing operation, and a processing operation for displaying a screen indicating an operation method for performing download of the printer driver can be performed. Moreover, in the present processing operation, a program other than the printer driver can be downloaded. The program other than the printer driver is, specifically, for example, a printing application for transmitting a print job to the printer 121 or a scanning application for transmitting a scan job to the printer 121. Moreover, the program other than the printer driver is, specifically, for example, an application for image layout for creating a layout image or an album by arranging images on a template.

In step S708, the second application 115 performs a processing operation for creating a print queue compatible with the printer 121 selected in step S704. In the present processing operation, the second application 115 instructs the OS to create a print queue compatible with the printer 121 selected in step S704. The print queue compatible with the printer 121 selected in step S704 being created enables the information processing apparatus 101 to cause the printer 121 selected in step S704 to perform printing. In response to a connection between the information processing apparatus 101 and the printer 121 selected in step S704 being established and the creation of a print queue compatible with the printer 121 being completed, the setup of the printer 121 is deemed to be completed (be successful).

Furthermore, the processing operation to be performed in step S708 can be a processing operation for displaying a screen including a button for displaying a print queue creation screen which is a screen for creation of a print queue for the printer 121 and is displayed by the OS. In response to the button being displayed, the second application 115 instructs the OS to display the print queue creation screen and displays, via a web browser, a web manual showing an operation method for creating a print queue in the print queue creation screen. In the print queue creation screen, a list of printers 121 found by the search conducted by the OS is displayed. In response to any one being selected by the user from the list, a print queue compatible with the selected printer 121 is created by the OS.

In step S709, the second application 115 transmits the print data acquired in step S701 to the printer 121 selected in step S704, thus causing the printer 121 selected in step S704 to perform test printing. After that, the second application 115 ends the processing in the present flowchart.

FIG. 8 is a flowchart illustrating processing concerning a location-based service. The processing in the present flowchart is implemented by the CPU 102 reading out a program stored in the ROM 106 onto the RAM 107 and executing the program. Furthermore, in the present exemplary embodiment, the information processing apparatus 101 is assumed to perform the processing via the second application 115. Moreover, the processing in the present flowchart is equivalent to the processing operation in step S702.

In step S801, the second application 115 determines whether the OS of the information processing apparatus 101 is an OS with a version higher than or equal to the predetermined version. The present processing operation is similar to that in step S212 which is performed by the first application 114. If the result of the determination is YES (YES in step S801), the second application 115 advances the processing to step S802, and, if the result of the determination is NO (NO in step S801), the second application 115 ends the processing in the present flowchart, and then advances the processing to step S703. Thus, if the result of the determination is NO, the second application 115 advances the processing to step S703 without performing step S802 to step S809, so that, even if the first setting is not currently set enabled, the second application 115 performs control in such a way as to prevent processing for setting the first setting enabled (a processing operation in step S803) from being performed. Moreover, even if the third setting is not currently set enabled, the second application 115 performs control in such a way as to prevent processing for setting the third setting enabled (a processing operation in step S803 or a processing operation in step S807) from being performed. Thus, if the result of the determination is NO, the second application 115 performs control irrespective of the setting content of the first setting in such a way as to prevent processing for setting the first setting enabled from being performed. Moreover, the second application 115 performs control irrespective of the setting content of the third setting in such a way as to prevent processing for setting the third setting enabled from being performed.

Furthermore, it is assumed to be possible to update the OS included in the information processing apparatus 101 from an OS with a version lower than the predetermined version to an OS with a version higher than or equal to the predetermined version. In that case, on one information processing apparatus 101, the second application 115 can output YES as the result of the determination or can also output NO as the result of the determination. Thus, on one information processing apparatus 101, the second application 115 outputs the result of the determination as NO in the determination performed at timing before updating of the OS, and outputs the result of the determination as YES in the determination performed at timing after updating of the OS. However, with regard to a configuration in which it is impossible to update an OS included in the information processing apparatus 101, on one information processing apparatus 101, the second application 115 outputs the result of the determination as only one of YES and NO. Thus, an information processing apparatus 101 in which the second application 115 is running in a case where the result of the determination becomes YES and an information processing apparatus 101 in which the second application 115 is running in a case where the result of the determination becomes NO are different from each other.

In step S802, the second application 115 determines whether at least one of the first setting and the third setting is currently set disabled. In the present processing operation, specifically, the second application 115 executes an OS standard API for acquiring, from the OS, information indicating whether the first setting is currently set enabled and an OS standard API for acquiring, from the OS, information indicating whether the third setting is currently set enabled. With this execution, the second application 115 acquires such pieces of information from the OS. Then, the second application 115 performs the present determination based on such acquired pieces of information. The case where at least one of the first setting and the third setting is currently set disabled is, specifically, a case where the first setting is currently set disabled or a case where, while the first setting is currently set enabled, the third setting is currently set disabled. Then, the case where at least one of the first setting and the third setting is not currently set disabled is, specifically, a case where both the first setting and the third setting are currently set enabled or a case where, while the first setting is currently set enabled, the third setting is currently in an initial state. If the result of the determination is YES (YES in step S802), the second application 115 advances the processing to step S803, and, if the result of the determination is NO (NO in step S802), the second application 115 advances the processing to step S804.

In step S803, the second application 115 performs processing for enabling the first setting and the third setting. Specifically, the second application 115 displays a second guidance screen for enabling the first setting and the third setting. FIG. 12B illustrates an example of a second guidance screen 1203 which is displayed in the present processing operation. The second guidance screen 1203 is displayed within a window which is displayed by the second application 115. The second guidance screen 1203 includes a message for prompting the user to set the first setting enabled and a message for prompting the user to set the third setting enabled. Furthermore, the message for prompting the user to set the first setting enabled is, in other words, a message for recommending the user to set the first setting enabled. The message for prompting the user to set the third setting enabled is, in other words, a message for recommending the user to set the third setting enabled. Moreover, the second guidance screen 1203 can include a message indicating that, to use the function of the second application 115 (for example, the function of performing connection setting processing), it is necessary to set the first setting or the third setting enabled. Furthermore, the second guidance screen 1203 is a screen which is displayed by the second application 115 without an OS standard API being used. Therefore, a message which is displayed in the second guidance screen 1203 is not a message the content of which is controlled by the OS but a message the content of which is controlled by the second application 115. A region 1204 included in the second guidance screen 1203 is a button for displaying the setting screen 600. In response to the region 1204 being pressed, the second application 115 instructs the OS standard setting application to display the setting screen 600. Specifically, the second application 115 executes an OS standard API for displaying the setting screen 600. This causes the setting screen 600 to be displayed, by the OS standard setting application, in a window different from the window at which the second guidance screen 1203 is currently displayed. The user performs an operation for setting the first setting enabled in the setting screen 600 which is currently displayed. Then, after performing the operation for setting the first setting enabled in the setting screen 600, the user operates a region 1205 included in the second guidance screen 1203. In a case where the region 1205 has been operated, the second application 115 advances the processing to step S804.

Furthermore, at timing when step S803 is performed, there is a case where the first setting is previously enabled. In that case, in the second guidance screen 1203 which is displayed in step S803, a message for prompting the user to set the third setting enabled only needs to be included and a message for prompting the user to set the first setting enabled does not need to be included. Moreover, at timing when step S803 is performed, there is a case where the third setting is previously enabled. In that case, in the second guidance screen 1203 which is displayed in step S803, a message for prompting the user to set the first setting enabled only needs to be included and a message for prompting the user to set the third setting enabled does not need to be included.

In step S804, the second application 115 determines whether both the first setting and the third setting are currently set enabled. In the present processing operation, specifically, the second application 115 executes an OS standard API for acquiring, from the OS, information indicating whether the first setting is currently set enabled and an OS standard API for acquiring, from the OS, information indicating whether the third setting is currently set enabled. With this execution, the second application 115 acquires such pieces of information from the OS. Then, the second application 115 performs the present determination based on such acquired pieces of information. If the result of the determination is YES (YES in step S804), the second application 115 ends the processing in the present flowchart and then advances the processing to step S703, and, if the result of the determination is NO (NO in step S804), the second application 115 advances the processing to step S805.

In step S805, the second application 115 determines whether the first setting is currently set enabled. In the present processing operation, specifically, the second application 115 executes an OS standard API for acquiring, from the OS, information indicating whether the first setting is currently set enabled and thus acquires the information. Then, the second application 115 performs the present determination based on whether the acquired information indicates that the first setting is currently set enabled. If the result of the determination is YES (YES in step S805), the second application 115 advances the processing to step S806, and, if the result of the determination is NO (NO in step S805), the second application 115 advances the processing to step S807.

In step S806, the second application 115 determines whether the third setting is currently set disabled. In the present processing operation, specifically, the second application 115 executes an OS standard API for acquiring, from the OS, information indicating what is the state concerning the third setting and thus acquires the information from the OS. Then, the second application 115 performs the present determination based on whether the acquired information indicates the state in which the third setting is currently set disabled. If the result of the determination is YES (YES in step S806), the second application 115 advances the processing to step S807, and, if the result of the determination is NO (NO in step S806), the second application 115 advances the processing to step S809. Furthermore, in a case where the information acquired in step S806 indicates the third setting is in an initial state, the result of the determination is NO. Moreover, the reason why, although the second guidance screen 1203 has been displayed in step S803, processing operations in step S804 and step S805 are performed is that there is a case where, although the second guidance screen 1203 has been displayed, the first setting or the third setting is still not enabled by the user.

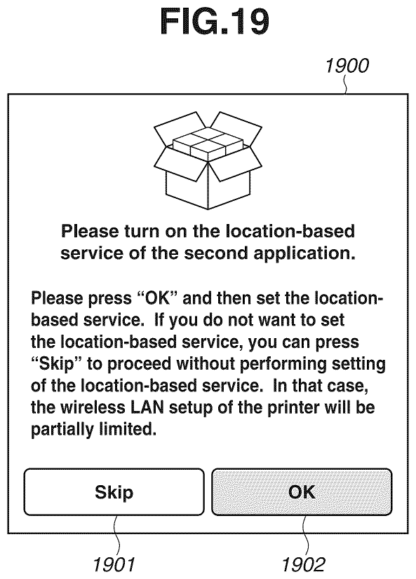

In step S807, the second application 115 displays a second notification screen for prompting the user to enable the first setting and the third setting. FIG. 19 illustrates an example of a second notification screen 1900 which is displayed in the present processing operation. The second notification screen 1900 includes a button 1901 and a button 1902. Moreover, the second notification screen 1900 includes a message for prompting the user to set the first setting enabled and a message for prompting the user to set the third setting enabled. Furthermore, the message for prompting the user to set the first setting enabled is, in other words, a message for recommending the user to set the first setting enabled. The message for prompting the user to set the third setting enabled is, in other words, a message for recommending the user to set the third setting enabled. Moreover, the second notification screen 1900 can include a message indicating that, to use the function of the second application 115, it is necessary to set the first setting or the third setting enabled. Furthermore, the second notification screen 1900 is a screen which is displayed by the second application 115 without an OS standard API being used. Therefore, a message which is displayed in the second notification screen 1900 is not a message the content of which is controlled by the OS but a message the content of which is controlled by the second application 115. The button 1901 is a button for selecting not changing the first setting or the third setting, and the button 1902 is a button for changing the first setting or the third setting. In response to any button being pressed in the second notification screen 1900, the second application 115 advances the processing to step S808.

In step S808, the second application 115 determines whether the button 1902 has been pressed in the second notification screen 1900. If the result of the determination is YES, the second application 115 returns the processing to step S803, thus displaying the second guidance screen 1203, and, if the result of the determination is NO, the second application 115 ends the processing in the present flowchart and then advances the processing to step S703.

In step S809, the second application 115 performs a processing operation for enabling the third setting. Specifically, the second application 115 performs a processing operation for displaying a dialog for enabling the third setting. More specifically, the second application 115 executes an OS standard API, which is an API for displaying a dialog for enabling the third setting and is used to request the use of a location-based service from the OS. In response to the API being executed, the dialog is displayed by the OS within a window which the second application 115 is currently displaying. FIG. 17B illustrates an example of a dialog 1703 which is displayed in the present processing operation. The dialog 1703 includes a button 1704 for enabling the third setting and a button 1705 for not enabling (for disabling) the third setting. Moreover, the dialog 1703 includes a message indicating that the second application 115 is trying to use a location-based service. The content of the message is controlled by the OS but is not able to be controlled by the second application 115. However, in the dialog 1703, a message which is able to be controlled by the second application 115 can also be displayed. Specifically, when an OS standard API for displaying the dialog 1703 is executed, the second application 115 communicates an optional message as an argument to the OS, so that the message can be displayed in the dialog 1703. Furthermore, in a case where the second application 115 does not communicate a message as an argument to the OS, a message which the second application 115 controls is not displayed in the dialog 1703. Furthermore, as the message which the second application 115 controls, for example, a message indicting that, to perform connection setting processing for the printer 121, it is necessary to permit the use of a location-based service is displayed. The message is, in other words, a message indicating that, to perform connection setting processing for the printer 121, it is necessary to enable the third setting. Moreover, the message which the second application 115 controls is, for example, a message indicating that, in a case where the use of a location-based service is not permitted, the connection setting processing for the printer 121 is not performed. The message is, in other words, a message indicating that, in a case where enabling of the third setting is not permitted, the connection setting processing for the printer 121 is not performed. In a case where the button 1704 has been operated by the user, the OS enables the third setting. Thus, the OS sets a state in which the third setting is currently set enabled. Additionally, the OS notifies the second application 115 that the button 1704 has been operated by the user. On the other hand, in a case where the button 1705 has been operated by the user, the OS disables the third setting. Thus, the OS sets a state in which the third setting is currently set disabled. Additionally, the OS notifies the second application 115 that the button 1705 has been operated by the user. In a case where the button 1704 or the button 1705 has been operated, the dialog becomes hidden. In a case where the button 1704 or the button 1705 has been operated, the second application 115 ends the processing in the present flowchart and then advances the processing to step S703.

While, in the above description, in step S807, a processing operation for executing, via the second application 115, an OS standard API for displaying the dialog 1703 is performed, the present exemplary embodiment is not limited to this configuration. Even if the third setting is in an initial state, the region 604 may be displayed within the region 602. Therefore, in step S807, for example, a processing operation for executing an OS standard API for displaying the setting screen 600 (a processing operation similar to the processing operation which is performed in a case where the region 1204 has been pressed) can be performed. Moreover, in step S807, for example, a processing operation for displaying the second guidance screen 1203 (a processing operation similar to that in step S803) can be performed.

FIG. 9 is a flowchart illustrating connection setting processing. Processing in the present flowchart is implemented by the CPU 102 reading out a program stored in the ROM 106 onto the RAM 107 and executing the program. Furthermore, in the present exemplary embodiment, the information processing apparatus 101 is assumed to perform the processing via the second application 115. Moreover, the processing in the present flowchart is equivalent to the processing operation in step S706.

In step S901, the second application 115 determines whether the interface (IF) selected in step S705 is an IF for wired LAN communication or an IF for USB communication. If the result of the determination is YES (YES in step S901), the second application 115 advances the processing to step S902, and, if the result of the determination is NO (NO in step S901), the second application 115 advances the processing to step S903. Furthermore, in a case where the IF selected in step S705 is an IF for wireless LAN communication, the result of the determination is NO.

In step S902, the second application 115 identifies a printer 121 which is connecting to the information processing apparatus 101 via the IF selected in step S705 and has been selected in step S704, and establishes a session between the identified printer 121 and the information processing apparatus 101. With this processing operation, the information processing apparatus 101 enters into a state of being able to communicate with the identified printer 121. After that, the second application 115 ends the processing in the present flowchart, and then advances the processing to step S707.

In step S903, the second application 115 determines whether the printer 121 selected in step S704 is a printer 121 found by the first search processing. Furthermore, the printer 121 found by the first search processing is a printer 121 which is operating with the connection setting mode. If the result of the determination is YES (YES in step S903), the second application 115 advances the processing to step S904, and, if the result of the determination is NO (NO in step S903), the second application 115 advances the processing to step S902.

In step S904, the second application 115 determines whether the OS of the information processing apparatus 101 is an OS with a version higher than or equal to the predetermined version. The present processing operation is similar to the processing operation in step S801. If the result of the determination is YES (YES in step S904), the second application 115 advances the processing to step S905, and, if the result of the determination is NO (NO in step S904), the second application 115 advances the processing to step S907. Thus, if the result of the determination is NO, the second application 115 advances the processing to step S907 without performing step S905, step S906, and step S908 described below, so that, even if both the first setting and the third setting are not currently set enabled, the second application 115 performs control in such a way as to prevent the second connection setting processing from being performed. Thus, if the result of the determination is NO, the second application 115 performs control irrespective of the setting contents of the first setting and the third setting in such a way as to prevent the second connection setting processing from being performed.

In step S905, the second application 115 determines whether the first setting is currently set enabled. The present processing operation is similar to the processing operation in step S805. If the result of the determination is YES (YES in step S905), the second application 115 advances the processing to step S906, and, if the result of the determination is NO (NO in step S905), the second application 115 advances the processing to step S908.

In step S906, the second application 115 determines whether the third setting is currently set enabled. The present processing operation is similar to the processing operation in step S806. If the result of the determination is YES (YES in step S906), the second application 115 advances the processing to step S907, and, if the result of the determination is NO (NO in step S906), the second application 115 advances the processing to step S908.

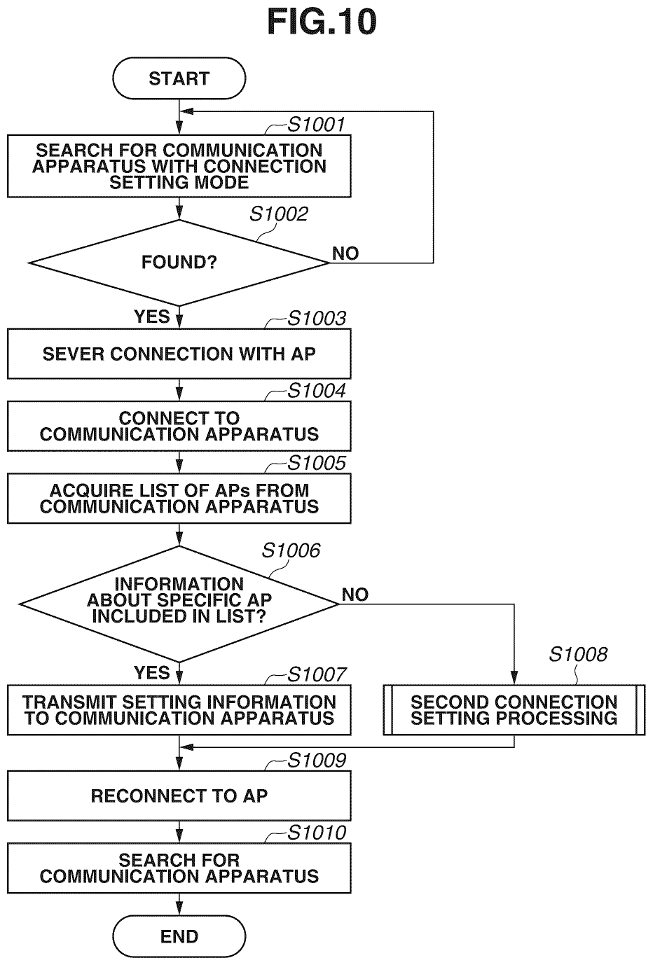

In step S907, the second application 115 performs the first connection setting processing. The details of the present processing operation are described below with reference to FIG. 10. After that, the second application 115 ends the processing in the present flowchart, and then advances the processing to step S707.

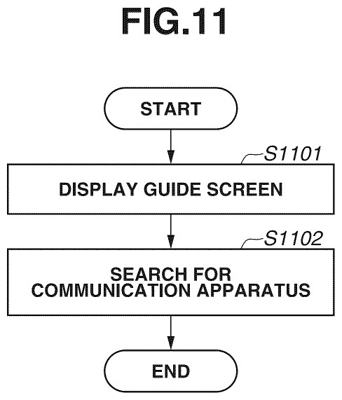

In step S908, the second application 115 performs the second connection setting processing. The details of the present processing operation are described below with reference to FIG. 11. After that, the second application 115 ends the processing in the present flowchart, and then advances the processing to step S707.

Furthermore, in the above description, the determination as to whether the OS of the information processing apparatus 101 is an OS with a version higher than or equal to the predetermined version is performed in both the flowchart of FIG. 8 and the flowchart of FIG. 9.

Moreover, the determination as to whether the first setting is currently set enabled and the determination as to whether the third setting is currently set enabled are performed in both the flowchart of FIG. 8 and the flowchart of FIG. 9.

However, the present exemplary embodiment is not limited to this configuration. For example, a configuration in which the above-mentioned determination is performed only in the flowchart of FIG. 8 and is not performed in the flowchart of FIG. 9 can be employed. In this configuration, on the assumption that the user enables both the first setting and the third setting with the processing in the flowchart of FIG. 8, the processing in the flowchart of FIG. 9 is performed. Therefore, in a case where the result of the determination in step S903 is YES, the second application 115 skips processing operations in step S904 to step S906 and then advances the processing to step S907. Moreover, for example, a configuration in which the above-mentioned determination is performed only in the flowchart of FIG. 9 and is not performed in the flowchart of FIG. 8 can be employed. In this configuration, after step S701, the second application 115 skips a processing operation in step S702 and then advances the processing to step S703. Moreover, in this configuration, the above-mentioned configuration in which, in the flowchart of FIG. 9, a processing operation similar to that in step S803 is performed is applied.

Moreover, while, in the above description, a configuration in which the processing operation in step S803 is performed based on at least one of the first setting and the third setting being currently set disabled has been described, the present exemplary embodiment is not limited to this configuration.

A configuration in which the processing operation in step S803 is necessarily performed irrespective of the setting state of the first setting or the third setting can be employed. Thus, specifically, for example, a configuration in which, in a case where the result of the determination in step S801 is YES, the second application 115 skips step S802 and then advances the processing to step S803 can be employed.

The details of the first connection setting processing are described as follows. FIG. 10 is a flowchart illustrating the first connection setting processing. Processing in the present flowchart is performed by the CPU 102 reading out a program stored in the ROM 106 onto the RAM 107 and executing the program. Furthermore, in the present exemplary embodiment, the information processing apparatus 101 is assumed to perform the processing via the second application 115. Moreover, the processing in the present flowchart is equivalent to the processing operation in step S907.

In step S1001, the second application 115 searches for a printer 121 which is operating with the connection setting mode and has been selected in step S704. In the present processing operation, specifically, the second application 115 executes an API for first search and thus instructs the OS to perform first search processing. Since the case where the first connection setting processing is performed is a case where an execution condition of the first search processing is satisfied, in the present processing operation, there is no case where, although the API for first search has been executed, the first search processing is not performed by the OS. In a case where the first search processing has been performed by the OS, the second application 115 acquires information indicating the result of the first search processing from the OS. The information indicating the result of the first search processing is information indicating an access point found by the first search processing. Therefore, the second application 115 identifies an access point which the printer 121 which is operating with the connection setting mode and has been selected in step S704 has enabled out of access points found by the first search processing. The case where the access point has been identified is a case where the printer 121 which is operating with the connection setting mode and has been selected in step S704 has been found in the present processing operation. The case where the access point has not been identified is a case where the printer 121 which is operating with the connection setting mode and has been selected in step S704 has not been found in the present processing operation.

In step S1002, the second application 115 determines whether the printer 121 which has been selected in step S704 has been found by the search conducted in step S1001. If the result of the determination is YES (YES in step S1002), the second application 115 advances the processing to step S1003, and, if the result of the determination is NO (NO in step S1002), the second application 115 returns the processing to step S1001.

In step S1003, the second application 115 stores, in a memory, information (an SSID and a password) concerning an access point to which the information processing apparatus 101 is currently connecting. After that, the second application 115 severs a connection between the information processing apparatus 101 and the access point. Furthermore, in a case where the information processing apparatus 101 is not currently connecting to the access point, the second application 115 skips the present processing operation.

In step S1004, the second application 115 establishes a connection between an access point which the printer 121 found by the search in step S1001 (i.e., the printer 121 selected in step S704) is enabling and the information processing apparatus 101. Thus, the second application 115 establishes a connection between the printer 121 selected in step S704 and the information processing apparatus 101. Furthermore, in the present exemplary embodiment, it is assumed that a password is not required for a connection to an access point which the printer 121 which is operating with the connection setting mode is enabling. In the following description, it is assumed that a communication between the information processing apparatus 101 and the printer 121 is performed via the connection established here.

In step S1005, the second application 115 acquires, from the printer 121 selected in step S704, a list of access points found by the first search processing which the printer 121 has performed.

In step S1006, the second application 115 determines whether an access point corresponding to the information stored in step S1003 is included in the list acquired in step S1005. If the result of the determination is YES (YES in step S1006), the second application 115 advances the processing to step S1007, and, if the result of the determination is NO (NO in step S1006), the second application 115 advances the processing to step S1008. Furthermore, it is assumed that, in a case where there is no information stored in step S1003, the result of the determination is NO.

In step S1007, the second application 115 transmits setting information including the information stored in step S1003 to the printer 121 selected in step S704. The information stored in step S1003 is, in other words, information required for connecting to an access point to which the information processing apparatus 101 has been connecting at timing of step S1003. In response to the information stored in step S1003 being transmitted to the printer 121, the printer 121 uses the transmitted information and thus connects to an access point corresponding to the transmitted information. After that, the second application 115 advances the processing to step S1009.

In step S1008, the second application 115 performs the second connection setting processing. The details of the second connection setting processing are described below with reference to FIG. 11.

In step S1009, the second application 115 uses the information stored in step S1003 and thus re-establishes a connection between an access point corresponding to the stored information and the information processing apparatus 101.

In step S1010, the second application 115 searches for a printer 121 on a network to which the information processing apparatus 101 belongs and which the access point to which the information processing apparatus 101 is connecting forms. Here, the printer 121 targeted for search is, specifically, the printer 121 serving as a transmission destination of the information in step S1007 and the printer 121 selected in step S704. Thus, the second application 115 executes an API for second search and thus causes the OS to perform the second search processing. Then, the second application 115 receives the result of the second search processing from the OS and identifies the printer 121 selected in step S704 out of apparatuses indicated by the result and found by the second search processing. In a case where the printer 121 has been found in the above-described way, the second application 115 ends the processing in the present flowchart, and then advances the processing to step S707. Furthermore, in the present processing operation, a search different from the second search processing can be conducted. Specifically, for example, the second application 115 can preliminarily acquire an IP address of the printer 121 selected in step S704 and, in step S1010, can perform unicast search processing using the acquired IP address.

Furthermore, in a case where there is no information stored in step S1003, the second application 115 skips step S1009 and step S1010 and then advances the processing to step S707.

The details of the second connection setting processing are described as follows. FIG. 11 is a flowchart illustrating the second connection setting processing. Processing in the present flowchart is performed by the CPU 102 reading out a program stored in the ROM 106 onto the RAM 107 and executing the program. Furthermore, in the present exemplary embodiment, the information processing apparatus 101 is assumed to perform the processing via the second application 115. Moreover, the processing in the present flowchart is equivalent to the processing operation in step S908.

In step S1101, the second application 115 displays, via a web browser, a guide screen (not illustrated) showing a method for a predetermined operation for establishing a connection between the printer 121 and the access point without transmitting the setting information from the information processing apparatus 101 to the printer 121. Specifically, the second application 115 instructs the web browser to display a screen with a uniform resource locator (URL) which the second application 115 preliminarily retains and which is provided for displaying the guide screen, thus causing the web browser to display the guide screen. Furthermore, the guide screen is displayed within a window which is different from a window displayed by the second application 115 and which is displayed by the web browser. Moreover, the predetermined operation is an operation which the user performs on the printer 121. Then, the predetermined operation includes, for example, an operation for causing the printer 121 to perform the first search processing, an operation for selecting any one of access points found by the first search processing, and an operation for inputting a password of the selected access point. However, the predetermined operation is not limited to this configuration, but can include, for example, an operation for causing the printer 121 to perform connection processing that is based on WPS or connection processing that is based on AOSS. WPS is an abbreviation for Wi-Fi Protected Setup. Moreover, AOSS is an abbreviation for AirStation One-Touch Secure System. Moreover, in the present processing operation, the second application 115 further displays, on a window which the second application 115 displays, a third guidance screen (not illustrated) for prompting the user to perform a predetermined operation according to a guide displayed in the guide screen. The third guidance screen is a screen which the second application 115 displays without the second application 115 executing an OS standard API. The third guidance screen to be displayed here includes a link button and a next button. The link button is a link button which is used to, in a case where the above-mentioned guide screen has been unintentionally closed, display the guide screen again via the web browser. After performing the predetermined operation according to the guide displayed in the guide screen, the user presses the next button. In response to the next button being pressed, the second application 115 advances the processing to step S1102.

Furthermore, while, in the above description, a configuration in which, in step S1101, displaying of the guide screen via the web browser is automatically performed based on the processing being advanced to step S1101 is described, the present exemplary embodiment is not limited to this configuration. Thus, displaying of the guide screen via the web browser does not need to be automatically performed based on the processing being advanced to step S1101. Then, displaying of the guide screen via the web browser can be performed for the first time in response to the link button included in the third guidance screen being operated.

Moreover, while, in the above description, a configuration in which the guide screen is displayed via the web browser is described, the present exemplary embodiment is not limited to this configuration. The guide screen can be displayed not within a screen which the web browser displays but within the third guidance screen which the second application 115 displays. Alternatively, the guide screen can be displayed within a screen which is different from the third guidance screen but which the second application 115 displays.

In step S1102, the second application 115 searches for the printer 121 selected in step S704 on a network to which the information processing apparatus 101 belongs and which the access point to which the information processing apparatus 101 is connecting forms. Thus, the second application 115 executes an API for second search and thus causes the OS to perform the second search processing. Then, the second application 115 receives the result of the second search processing from the OS and identifies the printer 121 selected in step S704 out of apparatuses indicated by the result and found by the second search processing. In a case where the printer 121 has been found in the above-described way, the second application 115 ends the processing in the present flowchart, and then advances the processing to step S707. Furthermore, in the present processing operation, a search different from the second search processing can be conducted. Specifically, for example, the second application 115 can preliminarily acquire an IP address of the printer 121 selected in step S704 and, in step S1010, can perform unicast search processing using the acquired IP address. After that, the second application 115 ends the processing in the present flowchart, and then advances the processing to step S707.

FIG. 13 is a flowchart illustrating an example of end processing of the second application 115. Processing in the flowchart of FIG. 13 is performed by the CPU 102 loading a control program stored in a memory such as the ROM 106 onto the RAM 107 and executing the control program. The present processing is processing which is performed after the processing in the flowchart of FIG. 7 ends.

In step S1300, the second application 115 starts the processing in the flowchart of FIG. 13.

In step S1301, the second application 115 determines whether the first application 114 is launching. If it is determined that the first application 114 is not launching (NO in step S1301), the second application 115 advances the processing to step S1302. On the other hand, if it is determined that the first application 114 is launching (YES in step S1301), the second application 115 advances the processing to step S1303. The second application 115 can issue an instruction to the OS with use of, for example, an application programming interface (API) to perform determination as to whether the first application 114 is launching.

In step S1302, the second application 115 performs processing for launching the first application 114. In the present processing operation, specifically, the second application 115 executes an API for launching the first application 114 and thus performs launch processing for issuing a launch instruction to the OS to launch the first application 114. After that, the CPU 102 advances the processing to step S1303.

In step S1303, the second application 115 transmits a setup result to the first application 114. Specifically, the second application 115 transmits, to the first application 114, a plurality of pieces of information, including information about success or failure of setup processing and identification information about the printer 121 targeted for setup, as a result of setup processing for the printer 121 in step S701 to step S708 illustrated in FIG. 7. Furthermore, in a case where setup of the printer 121 is failed, the identification information about the printer 121 does not need to be transmitted. The information about success or failure of setup processing is information indicating whether the second application 115 has succeeded in setup of the printer 121. The case where setup of the printer 121 is successful is a case where a connection between the information processing apparatus 101 and the printer 121 has been established by the connection setting processing performed in step S706. The case where setup of the printer 121 is failed is a case where, although the interface selected in step S705 is a wireless LAN and the connection information has been transmitted to the printer 121, the printer 121 selected in step S704 has not been found. Moreover, the case where setup of the printer 121 is failed is, for example, a case where, although the interface selected in step S705 is a wired LAN or USB and the above-mentioned various guidance screens have been displayed, the printer 121 selected in step S704 has not been found. As an example of the information about success or failure of setup processing included in the setup result, there is a method of representation using character string information in such a manner that, in a case where the various processing operations in step S701 to step S708 illustrated in FIG. 7 are successful, the information is “SETUP_SUCCESS” and, in the other cases, the information is “SETUP_FAIL”. Moreover, as an example of the identification information about the printer 121 included in the setup result, there is identification information which is able to be acquired when the printer 121 has been detected in the printer search processing performed in step S703 or the connection setting processing for the printer 121 performed in step S706. The identification information is, for example, the model name, media access control (MAC) address, and serial number of the printer 121. There is a case where it is not possible to identify, with a single piece of identification information, one printer 121 out of printers which have been set up, such as a case where a plurality of printers 121 with the same model name has been detected. Therefore, the second application 115 can transmit a setup result including a plurality of pieces of identification information to the first application 114.

An example of a method in which, in step S1303, the second application 115 transmits a setup result to the first application 114 is described as follows. For example, a method in which the second application 115 makes the setup result into character string information such as that mentioned above and stores the character string information in a file which is provided in the ROM 106 and to which the first application 114 is able to refer and the first application 114 refers to the file can be used. Alternatively, a method of appending the setup result as command line arguments to a launch instruction issued when the second application 115 launches the first application 114 can be used. In an alternative way, for example, a method of transmitting the setup result via an interprocess communication with the first application 114 in the process of launching can be used.

In response to the setup result being communicated to the first application 114 in step S1303, the first application 114 performs processing operations in step S210 and subsequent steps. Furthermore, in the present exemplary embodiment, since, in response to the setup result being communicated, the first application 114 is activated, the setup result can be said to be a notification for activating the first application 114.

In step S1304, the second application 115 performs processing for ending the operation of the second application 115 itself. Specifically, the second application 115 closes all together windows or screens which the second application 115 is displaying, and then ends the process of the second application 115 itself.

In step S1305, the second application 115 ends the processing in the flowchart of FIG. 13.

Furthermore, in the above description, a configuration in which the second application 115 determines whether the first application 114 is launching and, if it is determined that the first application 114 is not launching, the second application 115 performs processing for launching the first application 114 is described. However, the present exemplary embodiment is not limited to this configuration, and the second application 115 can perform processing for launching the first application 114 irrespective of whether the first application 114 is launching. Furthermore, in response to the processing for launching the first application 114 being performed, a notification is transmitted from the OS to the first application 114. In response to the processing for launching the first application 114 being performed in a state in which the first application 114 has been launched, the first application 114 becomes activated while maintaining the state in which the first application 114 has been launched. Therefore, the processing for launching the first application 114 can be said to be processing for activating the first application 114.

Moreover, the processing operation in step S209 which the first application 114 performs can be processing for determining whether the processing for launching the first application 114 has been performed by the second application 115.

With such a configuration employed, the first application 114 becomes able to perform the automatic search function at appropriate timing or automatically perform changing of the automatic search setting at appropriate timing. Moreover, the second application 115 also becomes able to automatically perform changing of the automatic search setting at appropriate timing.

While, in the above description, a configuration in which the first search processing is performed in processing which is processing for performing connection setting processing and which is provided for searching for a printer 121 which operates with the connection setting mode has been described, the present exemplary embodiment is not limited to this configuration. The first search processing is processing for searching for a device which operates as an access point by the communication standard in the IEEE 802.11 series. Therefore, the first search processing is able to be performed in various processing operations other than the processing for performing connection setting processing, as long as those are processing for connecting to an access point. Therefore, the determination as to whether the OS of the information processing apparatus 101 is an OS with a version higher than or equal to a predetermined version, such as that described above, can be performed in various processing operations other than the processing for performing connection setting processing. Similarly, the determination as to whether the first setting is currently set enabled and the determination as to whether the third setting is currently set enabled can also be performed in various processing operations other than the processing for performing connection setting processing. The various processing operations other than the processing for performing connection setting processing include, for example, processing operations for establishing a connection between an access point found by the search and a terminal device, transmitting various pieces of information other than the setting information to the access point, and receiving the various pieces of information from the access point. The various pieces of information other than the setting information include, for example, image data, print data, and audio data.

Moreover, while, in the above description, a configuration in which the OS included in the information processing apparatus 101 is macOS has been described, the present exemplary embodiment is not limited to this configuration. The OS included in the information processing apparatus 101 can be another OS such as Android® OS or iOS®.

Moreover, while, in the above description, a configuration in which the first search processing is search processing which is performed in the communication standard in the IEEE 802.11 series has been described, the present exemplary embodiment is not limited to this configuration. For example, the first search processing can be search processing which is performed via Bluetooth®.

Moreover, in a case where the automatic search setting has been enabled in response to the checkbox 1601 being operated in the screen illustrated in FIG. 16, a determination similar to that in step S222 can be performed. Then, if the result of the determination is YES, a determination similar to that in step S227 can be performed. Then, if the result of the determination is NO, a determination similar to that in step S228 can be performed. Then, if the result of the determination is YES, a determination similar to that in step S229 can be performed. Then, if the result of the determination is NO, a determination similar to that in step S230 can be performed. Then, if the result of the determination is YES, a determination similar to that in step S231 can be performed, and, if the result of the determination is NO, a determination similar to that in step S232 can be performed. Thus, even in a case where the automatic search setting has been enabled in response to the checkbox 1601 being operated, processing for enabling the first setting or processing for enabling the second setting can be performed based on the current setting content of the first setting or the second setting.

Moreover, aspects of the present disclosure are also attained by supplying a storage medium storing program code of software for implementing the functions of the above-described exemplary embodiment to a system or apparatus. Thus, aspects of the present disclosure are also attained by a computer (a CPU or a micro processing unit (MPU)) of the system or apparatus reading out and executing the program code stored in the storage medium. In this case, the program code itself read out from the storage medium implements the functions of the above-described exemplary embodiment, and the storage medium storing the program code constitutes aspects of the present disclosure.

Examples of the storage medium for supplying the program code to be used include a flexible disc, a hard disk, an optical disc, a magnetic optical disc, a compact disc read only memory (CD-ROM), a CD recordable (CD-R), a magnetic tape, a non-volatile memory card, a ROM, and a digital versatile disc (DVD).

Moreover, a case where, based on the program read out by the computer, for example, an OS which is running on the computer performs part of or all of the actual processing to implement the functions of the above-described exemplary embodiment can also be naturally included in aspects of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-014585 filed Feb. 2, 2024, which is hereby incorporated by reference herein in its entirety.

What is claimed is:

1. A control method for an information processing apparatus including a first application program, the control method comprising:
performing launch processing for launching a second application program capable of performing processing for first search processing which is processing to be performed based on a predetermined setting for using a location-based service of the information processing apparatus being enabled in the information processing apparatus and which is processing for searching for one or a plurality of communication apparatuses;
in a case where, although processing for activating the first application program has been performed by the second application program after predetermined processing including processing for the first search processing has been performed by the second application program launched based on the launch processing having been performed, the predetermined setting is not enabled in the information processing apparatus, disabling a specific setting for performing a predetermined function, which is a function of the first application program and is a function including processing for the first search processing; and
in a case where the specific setting is enabled, performing the predetermined function based on the first application program having launched and, in a case where the specific setting is disabled, not performing the predetermined function even if the first application program has launched.

2. The control method according to claim 1, further comprising, in a case where, after the predetermined processing has been performed by the second application program launched based on the launch processing having been performed, processing for activating the first application program is performed by the second application program and the predetermined setting is enabled in the information processing apparatus, performing the predetermined function based on processing for activating the first application program having been performed by the second application program.

3. The control method according to claim 2,
wherein the predetermined setting is a first setting for permitting an application program included in the information processing apparatus to use the location-based service,
wherein a second setting different from the first setting is a setting for selecting the first application program as the application program which is permitted to use the location-based service, and
wherein the control method further comprises, in a case where, after the predetermined processing has been performed by the second application program launched based on the launch processing having been performed, processing for activating the first application program is performed by the second application program and the first setting and the second setting are enabled in the information processing apparatus, performing the predetermined function based on processing for activating the first application program having been performed by the second application program.

4. The control method according to claim 1,
wherein the predetermined setting is a first setting for permitting an application program included in the information processing apparatus to use the location-based service,
wherein a second setting different from the first setting is a setting for selecting the first application program as the application program which is permitted to use the location-based service, and
wherein the control method further comprises, in a case where, after the predetermined processing has been performed by the second application program launched based on the launch processing having been performed, processing for activating the first application program is performed by the second application program and, while the first setting is enabled in the information processing apparatus, the second setting is not enabled in the information processing apparatus, performing processing for enabling the second setting.

5. The control method according to claim 1, further comprising, in a case where one or a plurality of communication apparatuses has been found by the predetermined function being performed, performing the launch processing.

6. The control method according to claim 1,
wherein the launch processing is performed based on the first application program having been launched for first time in the information processing apparatus, and
wherein, in a case where launching of the first application program is launching performed for second and subsequent times in the information processing apparatus, the launch processing is not performed based on the first application program having been launched in the information processing apparatus.

7. The control method according to claim 1,
wherein, in a case where launching of the first application program is launching performed for second and subsequent times in the information processing apparatus and the predetermined setting is enabled, the predetermined function is performed based on the first application program having been launched, and
wherein, in a case where launching of the first application program is launching performed for second and subsequent times in the information processing apparatus and the predetermined setting is disabled, the predetermined function is not performed even if the first application program has been launched.

8. The control method according to claim 1,
wherein, in a case where launching of the first application program is launching performed for second and subsequent times in the information processing apparatus and the predetermined setting is disabled, processing for enabling the predetermined setting is performed, and
wherein, in a case where launching of the first application program is launching performed for first time in the information processing apparatus, after the predetermined processing has been performed by the second application program launched based on the launch processing having been performed, processing for activating the first application program is performed by the second application program, and the predetermined setting is disabled, processing for enabling the predetermined setting is not performed and processing for disabling the specific setting is performed.

9. The control method according to claim 8,
wherein the predetermined setting is a first setting for permitting an application program included in the information processing apparatus to use the location-based service,
wherein a second setting different from the first setting is a setting for selecting the first application program as the application program which is permitted to use the location-based service,
wherein, in a case where launching of the first application program is launching performed for second and subsequent times in the information processing apparatus and the first setting and the second setting are enabled, the predetermined function is performed based on the first application program having been launched, and
wherein, in a case where launching of the first application program is launching performed for first time in the information processing apparatus, after the predetermined processing has been performed by the second application program launched based on the launch processing having been performed, processing for activating the first application program is performed by the second application program, and the first setting and the second setting are enabled, the predetermined function is performed based on processing for activating the first application program having been performed by the second application program.

10. The control method according to claim 9,
wherein, in a case where launching of the first application program is launching performed for second and subsequent times in the information processing apparatus and, while the first setting is enabled, the second setting is disabled, processing for enabling the second setting is performed, and
wherein, in a case where launching of the first application program is launching performed for first time in the information processing apparatus, after the predetermined processing has been performed by the second application program launched based on the launch processing having been performed, processing for activating the first application program is performed by the second application program, and, while the first setting is enabled, the second setting is disabled, processing for enabling the second setting is performed.

11. The control method according to claim 1,
wherein the launch processing includes processing for displaying a region for receiving, from a user, an operation for launching the second application program and a region for receiving, from the user, an operation for not launching the second application program,
wherein, in a case where the operation for launching the second application program has been received, the second application program is launched, and
wherein, in a case where the operation for not launching the second application program has been received, the second application program is not launched.

12. The control method according to claim 1, further comprising, in a case where, after the predetermined processing has been performed, processing for activating the first application program has been performed by the second application program, performing registration processing for registering, with the first application program, the one or the plurality of communication apparatuses found by processing for the first search processing having been performed by the second application program.

13. The control method according to claim 1, further comprising, in a case where, even if the specific setting is disabled, a predetermined operation has been performed in a screen which is displayed in the first application program after the first application program has launched, performing the predetermined function.

14. The control method according to claim 1, further comprising, in a case where a predetermined operation has been performed in a screen which is displayed in the first application program after the first application program has launched, displaying a setting screen for receiving an operation for enabling or disabling the specific setting,
wherein, in a case where the operation for enabling the specific setting has been received in the setting screen, the specific setting is enabled,
wherein, in a case where the operation for disabling the specific setting has been received in the setting screen, the specific setting is disabled, and
wherein, in a case where, after the predetermined processing has been performed by the second application program launched based on the launch processing having been performed, while processing for activating the first application program has been performed by the second application program, the predetermined setting is not enabled in the information processing apparatus, the specific setting is disabled without the operation for disabling the specific setting being received in the setting screen.

15. The control method according to claim 1, further comprising transmitting a print job for causing printing to be performed or a scan job for causing scanning to be performed to one of the one or the plurality of communication apparatuses found by processing for the first search processing.

16. The control method according to claim 1,
wherein an operating system (OS) of the information processing apparatus is an OS with a version higher than or equal to a predetermined version, and
wherein, in the information processing apparatus including an OS with a version higher than or equal to the predetermined version, the first search processing is processing which is not performed unless the predetermined setting is enabled in the information processing apparatus.

17. The control method according to claim 1, wherein the first search processing is processing for searching for the one or the plurality of communication apparatuses each of which operates as an access point, by a communication standard in IEEE 802.11 series.

18. The control method according to claim 1,
wherein the processing for activating the first application program is at least one of processing for launching the first application program and processing for notifying the first application program of predetermined information, and
wherein, in a case where the processing for activating the first application program has been performed by the second application program, the first application program is activated and operates in foreground.

19. A non-transitory computer-readable storage medium storing a program that, when executed by a computer of an information processing apparatus including a first application program, causes the computer to perform a method comprising:
performing launch processing for launching a second application program capable of performing processing for first search processing which is processing to be performed based on a predetermined setting for using a location-based service of the information processing apparatus being enabled in the information processing apparatus and which is processing for searching for one or a plurality of communication apparatuses;
in a case where, although processing for activating the first application program has been performed by the second application program after predetermined processing including processing for the first search processing has been performed by the second application program launched based on the launch processing having been performed, the predetermined setting is not enabled in the information processing apparatus, disabling a specific setting for performing a predetermined function, which is a function of the first application program and is a function including processing for the first search processing; and
in a case where the specific setting is enabled, performing the predetermined function based on the first application program having launched and, in a case where the specific setting is disabled, not performing the predetermined function even if the first application program has launched.

20. An information processing apparatus including a first application program, the information processing apparatus comprising:
a first launching unit configured to perform launch processing for launching a second application program capable of performing processing for first search processing which is processing to be performed based on a predetermined setting for using a location-based service of the information processing apparatus being enabled in the information processing apparatus and which is processing for searching for one or a plurality of communication apparatuses;
a disabling unit configured to, in a case where, although processing for activating the first application program has been performed by the second application program after predetermined processing including processing for the first search processing has been performed by the second application program launched based on the launch processing having been performed, the predetermined setting is not enabled in the information processing apparatus, disable a specific setting for performing a predetermined function, which is a function of the first application program and is a function including processing for the first search processing; and
a first execution unit configured to, in a case where the specific setting is enabled, perform the predetermined function based on the first application program having launched and configured to, in a case where the specific setting is disabled, not perform the predetermined function even if the first application program has launched.
